(19) United States
(12) Patent Application Publication
(10) Pub. No.: US 2014/0172589 A1
(43) Pub. Date: Jun. 19, 2014

(54) Deal Package Management Systems And Methods Of Use

(71) Applicant: Xplorit, LLC, Reno, NV (US)

(72) Inventors: Douglas Lincoln Rhiner, Fairfax, CA (US); Derek Eugene Swanson, Incline Village, NV (US)

(73) Assignee: XPLORIT, LLC, Reno, NV (US)

(21) Appl. No.: 14/108,317

(22) Filed: Dec. 16, 2013

Related U.S. Application Data
(60) Provisional application No. 61/737,622, filed on Dec. 14, 2012.

(51) Int. Cl. G06Q 30/02

(52) U.S. Cl. CPC G06Q 30/0276
USPC 705/14.72

(57) ABSTRACT

A deal creation system and method are disclosed. In one embodiment, the deal creation system can provide deal and package configuration, management, and promotion features such that deal creators and package creators can configure a deal package containing multiple deals from different vendors. In some embodiments, the deal creation system allows a deal creator to designate a deal as a standalone deal to be presented to consumers individually with the retail value and discount amount visible to the consumer or as a deal that can be included in a deal package when presented to consumers. In some applications, the deal promotion system can maintain the remaining deal count for a given deal across multiple deal packages provided by the same or different entities. Some instances of the deal promotion system can manage conflicting blackout dates and deal restrictions for different deals from different vendors packaged in a single deal package.

### CROSS-REFERENCE TO RELATED APPLICATIONS

The present application for patent claims priority through the applicants' prior U.S. provisional patent application, entitled: Dynamic Aspect Retention System and Method of Use, Application No. 61/737,622, filed Dec. 14, 2012, which is hereby incorporated by reference in its entirety.

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright right.

### FIELD OF INVENTION

The technology of the present application relates to an automated deal promotion system and method, and more particularly to a system and method for deal and package configuration, and automated deal and package promotion.

### BACKGROUND

Historically, businesses have attempted to increase their market reach for a given good, service, or both through a variety of means. One such way is through flash sale sites such as Groupon®, LivingSocial®, and Google Offers®. These flash sites generally involve a business creating a discounted offering (e.g. a deal) that is then presented directly to a large number of consumers. The discount amount is defined by the business, along with a minimum number of required deal acceptances during a defined period of time, which will serve to “tip” the deal such that previously accepted deal transactions are executed. As a result, failure to tip a deal in the defined time period results in no transactions being executed and termination of the deal.

To the applicants' knowledge, these types of tip triggered systems have the disadvantage of requiring a large number of purchasers, and can also require deeper discounting than might be necessary for more targeted marketing efforts. They also have not provided a way to hide the discount amount of each offer or to combine the deal with other deals in a deal package.

Thus, to the applicants' knowledge, tip triggered systems have not provided a vehicle f for deal packaging businesses, such as hotels or travel agents for example. to interact with other vendors to include their deals in a deal package, or to request that certain vendors submit proposed deals for inclusion in tailored deal package. Tip trigged platforms also have not enabled a consumer to purchase a variety of goods or services, and traditionally lack a catalogue or have a very small catalogue for users to browse and select items to purchase. As a result, these platforms have limited the ability of vendor's to provide deals while providing a less than optimal consumer experience as well.

Such tip triggered systems inherently require a consumer to wait for the needed group to be assembled in order to tip the deal and thus achieve a discount. In contrast, many e-commerce platforms, and the typical brick-and-mortar purchase experience, offer an “Instant Buy” option to allow consumers to buy a product without waiting. Consequently, at least some consumers are likely to be frustrated by having to wait for the tip to take place and possibly have waited their time if the tip does not happen. In addition, for those who do not wait for a tip to take place and instead opt for an instant buy option, they too can become frustrated if they find that others have received a better price through the tip taking place later.

In other contexts, attempts to increase market share by businesses have sometimes included grouping or bundling two or more deals together. To extract more revenue from consumers, these methods have utilized different techniques for framing how the deals are bundled, such as by emphasizing which deal is the primary deal in the bundle, discounting a particular deal in a bundle, etc. However, to applicants' knowledge, these techniques have not been implemented in such a way as to facilitate businesses offering and combining vastly different goods, services, or both. Furthermore, these grouping techniques do not facilitate businesses easily soliciting deal offers from multiple vendors without the time and issues associated with direct negotiations. These grouping techniques have also traditionally lacked a way to account for the promotion of a maximum number of deals across multiple deal packages such that a deal is not oversold.

### SUMMARY

The Applicants believe that they discovered the problems and issues with prior art systems noted above as well as solutions and advantages provided by differing embodiments of the deal promotion platform and methods of creating deal packages disclosed in this specification. Briefly and in general terms, the present invention is directed to a deal promotion platform or system that provides one or more among deal creation, deal configuration, and package or deal package configuration features such that deal creators and package creators can configure a deal package containing multiple deals from differing vendors.

In some embodiments, the deal promotion platform enables a business to determine the deal discount for a given deal, and the total quantity of deals they are willing to sell at a discounted price. This can, in some embodiments, provide the advantage of executing redemption code creation at the time the deal is published rather than waiting until the deal is tipped. As a result, if desired, deals with valid redemption codes can be included in deal packages immediately upon publication of a deal.

Some embodiments of the deal promotion platform include the ability for a deal creator to designate a deal as a stand-alone deal or to be included in a deal package. Stand-alone deals can be presented to consumers individually such that the retail value and discount amount are visible to the consumer. Package-inclusion deals, by contrast, are deals that can be included in a deal package when presented to consumers.

In certain instances, when a business, which may be a package creator, includes multiple deals in a deal package, the discount associated with each associated deal may be hidden or not visible to the consumer. Instead the package value of the deal package and the package discount may be presented to consumers. The package discount can be determined by the business creating the deal package, which can have no impact on the payment amount to the deal vendor. This feature can enable a business, for example, to provide narrowly-targeted (possibly deeper discounts) for a deal package that it might not otherwise offer if consumers or competitors could discover the discount amount for the particular deal in a deal package.

In some embodiments, the deal promotion platform additionally can provide a deal creator interface enabling vendors to control which businesses can include a particular deal in a deal package. Tailored deals therefore can be created for packaging by a single business, or deals can be created and targeted to a group of businesses with a common attribute, such as geographic location.

Some instances of the deal promotion platform can also provide an interface for businesses to request deals for inclusion in a deal package. The request can be sent to a single deal vendor, or to a group of vendors based on a common attribute or category, such as snow sports.

In some embodiments, the deal promotion platform may keep a running count of the deals that have been sold and may reduce the running count of available deals by subtracting the deals sold from the maximum deals as defined by the deal creator when the deal was created. Accordingly, the deal promotion platform can resolve the remaining deal count across multiple deal packages provided by the same business, different businesses, or both. In some applications, this can avoid the problem of overselling of discounted deals.

Some embodiments of the deal promotion platform can also manage conflicting blackout dates and deal restrictions for different deals from different vendors packaged in a single deal package. For example, a deal package might include one deal redeemable only on weekdays and another deal redeemable only on the weekends. In certain instances, the deal promotion platform or system can detect the conflicting blackout dates and restrictions, and can provide one or more among notifying the package creator of the conflict, or preventing the deal package from being created, or both notifying the package creator of conflict and preventing package creation.

Some embodiments of the deal promotion platform can also act as a catalog of deals and deal vendors for businesses that create deal packages, offer standalone deals as part of their business, or both.

As noted above, the applicants believe they have discovered that existing deal creation systems or platforms present real problems for business to business to consumer deal management, package management, and vendor relations platforms. As a result, at least some embodiments of the disclosed deal creation platform can enable differing businesses to leverage the marketing reach of one another, reduce friction in deal and deal package development, and better tailor deal creation, management, and packaging in a multi-vendor/multi-business environment. In addition, certain instances of the deal promotion platform can provide the user with the ability to create discounted deals in a way that does not require the high volume, deep discounting approaches of traditional flash sale systems.

It is to be understood that the foregoing is only a brief summary of some aspects of this specification. The present specification discloses many other novel features, problem solutions, and advantages. They will become apparent as this specification proceeds. Thus, the scope of a given claim is to be determined by the claim as issued and not by whether it addresses an issue set forth in the above Background or includes a feature set forth in this brief Summary.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a computer network or similar digital processing environment in which a deal promotion platform can be implemented according to an exemplary embodiment;

FIG. 2 is a block diagram of the internal structure of a computer or device operable in the computer network of FIG. 1;

FIG. 3 is an application layer diagram of a deal promotion platform operable in the computer network of FIG. 1;

FIG. 4 is a block diagram of a deal table and a package table utilized by the application layer diagram of FIG. 3;

FIGS. 5A and 5B are flowcharts of processes for configuring a deal in the deal promotion platform of FIG. 3;

FIG. 6A through 6C are flowcharts of processes for configuring a deal package in the deal promotion platform of FIG. 3;

FIG. 7 is a flowchart of a process for resolving deal conflicts in a deal package in the deal promotion platform of FIG. 3;

FIGS. 8 through 16 are screen captures of a graphical user interface for entering deal configuration information by a user and receiving by the deal promotion platform of FIG. 3; and

FIGS. 17A through 18 are screen captures of a graphical user interface for entering package configuration information by a user and receiving by the deal promotion platform of FIG. 3.

### DETAILED DESCRIPTION

Broadly, this disclosure is directed towards improved systems, methods, and/or apparatuses for providing an automated deal promotion system that combines deal creation and deal configuration features with automated deal packaging management features to allow deal creators and package creators to configure deal packages containing multiple deals. The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Certain embodiments of the deal promotion system or platform and methods are described with reference to methods, apparatus (systems), and computer program products that can be implemented by computer program instructions. These computer program instructions can be provided to a processor of a general purpose computer, special purpose computer, mobile computing device, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices such as, for example, a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a computer terminal. In the alternative, the processor and the storage medium can reside as discrete components in a computer terminal.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently such as, for example, through multi-threaded processing, interrupt processing, or multiple processors or processor cores, rather than sequentially. Moreover, in certain embodiments, acts or events can be performed on alternate tiers within the architecture. As described herein, a deal may also be referred to as a deal proposal, with both terms indicating a deal being submitted by, for example a deal creator or vendor, in a deal promotion platform or system. Furthermore, as described herein, a package or a deal package may both describe a bundle of two or more deals.

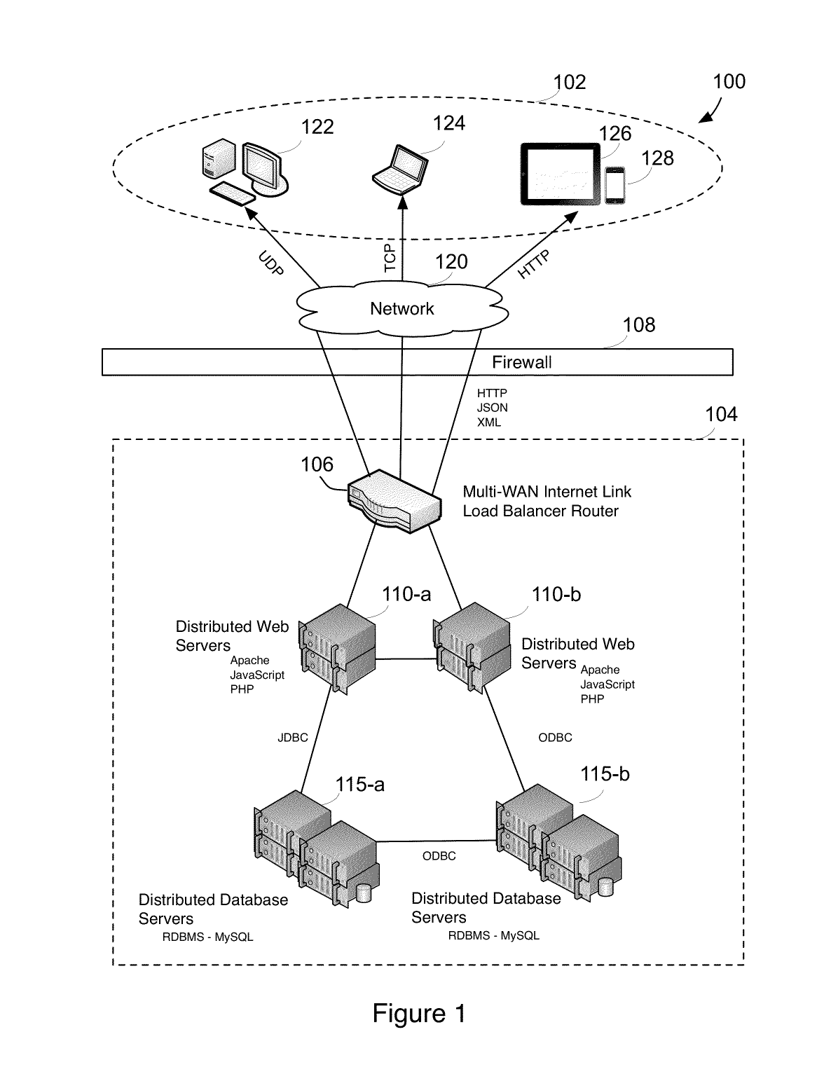

With reference now to FIG. 1, a computer network or similar digital processing environment 100 in which the system and method disclosed can be implemented. The present systems and methods can also run on different architectures that include a LAN, WAN, stand-alone PC, stand-alone mobile device, a stand-alone, clustered, or networked mini or mainframe computers, etc. The deal promotion system and method of use can be distributed on multiple computers and devices 102, 104.

FIG. 1 is representative of many specific computing arrangements that can support the system and method disclosed. In one embodiment, the software implementing the deal promotion system runs in the Linux® environment on an i686 architecture. In another embodiment, the software is implemented to run in other environments, such as Windows®, UNIX®, and to run on any hardware having enough power to support timely operation of software such as that identified in FIG. 1. In some implementations of the deal promotion system, a Linux® distribution, such as, for example, Ubunutu®, is deployed on one or more server computers 104. In an alternate embodiment, computers are deployed as virtual instances rather than physical computers.

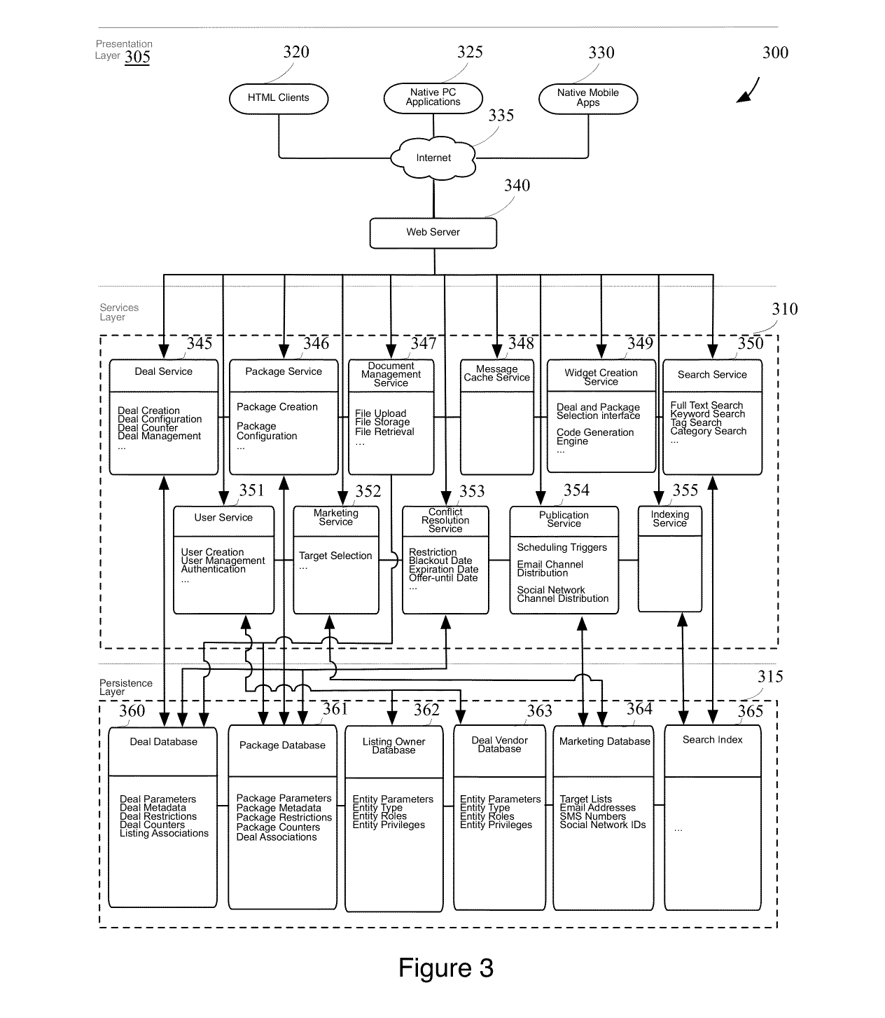

A load balancing router 106, such as for example a Peplink Multi Wan Router, can distribute traffic inside a firewall 108 to and from distributed web servers 110-a, 110-b. In some deployments, these webservers 110-a, 110-b are distributed instances of an Apache web server, such as Apache 2.2.25, with a distribution of PHP installed, such as PHP 5.4.18, an instance of Node.js installed, or both, along with supporting libraries such as those configured for communicating with persistent data stores. The distributed web servers 110-a, 110-b are communicatively coupled to computers 115-a, 115-b hosting one or more persistent data stores. The data stores 115-a, 115-b can be distributed relational databases such as, for example, MySQL® 5.1.70 or SQL Server® storing primary and derivative data generated by the deal and package services 345, 346 of FIG. 3. In an example, a distributed web server 110 may communicate with a distributed database server 115 via Java Database Connectivity (JDBC), Open Database Connectivity (ODBC), or other database communication protocol supported by the data store. The distributed database servers 115-a and 115-b may also communicate with each other via ODBC or other database communication protocol. In addition, or alternatively, the distributed database servers 115 may host XML databases, object oriented databases, NoSQL database, and the like.

Client computers of various types 102 can connect to a remote server infrastructure 104 via a network 120 over one or more communication protocols. All computers can pass information as unstructured data, structured files, structured data streams such as, for example, XML, structured data objects such as, for example, JSON objects, and/or structured messages. Client computers 122, 124, 126, 128 may communicate over various protocols such as, for example, UDP, TCP/IP and/or HTTP. In some cases, one or more client computers 122, 124, 126, 128 may communicate via a wireless connection with the network 120.

In some embodiments, the wireless connection between one or more client computers 102 and the network 120 may implement or be part of a system that implements CDMA, TDMA, FDMA, OFDMA, SC-FDMA, and/or other wireless communication technologies. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2).

Client computers and devices 122, 124, 126, 128 and server computers 104 provide processing, storage, and input/output devices executing application programs. Client computers 102 can also be linked through communications network 120 to other computing devices, including other client devices/processes 102 and server computers 104. In some embodiments, server computers 115-a, 115-b host and execute software implementing centralized persistent data storage and retrieval. The network 120 can be a local area network and/or a wide area network that is part of a remote access network, a global network (e.g., the Internet), a worldwide collection of computers, and/or gateways that currently use respective protocols (TCP/IP, UDP, etc.) to communicate with one another. Multiple client computer devices 102 may each execute and operate instances of the applications accessing the deal promotion platform or system.

On reading this disclosure, those of skill in the art will recognize that many of the components discussed as separate units may be combined into one unit and an individual unit may be split into several different units. Further, the various functions could be contained in one computer or distributed over several networked computers and/or devices. The identified components may be upgraded and replaced as associated technology improves and advances are made in computing technology.

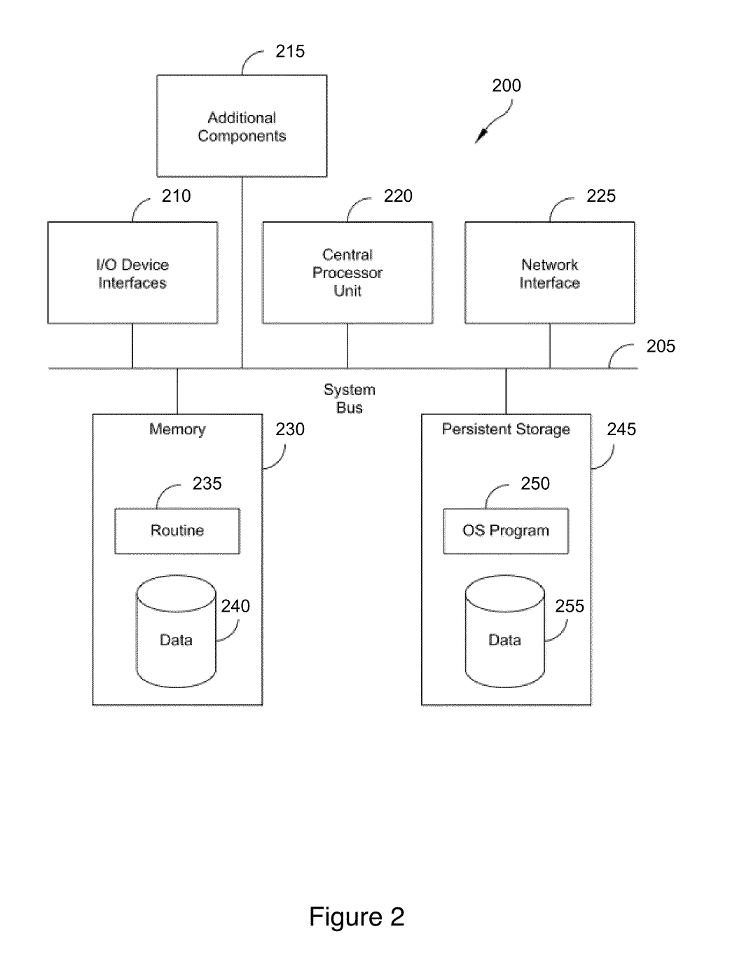

With reference to FIG. 2, each component of the system 200 is connected to a system bus 205, providing a set of hardware lines used for data transfer among the components of a computer or processing system. Also connected to the bus 205 are additional components 210 of the promotion platform, such as additional memory storage, digital processors, network adapters, and I/O devices. The bus 205 is essentially a shared conduit connecting different elements of a computer system (e.g., processor, disk storage, memory, input/output ports, network ports, etc.) and enabling transfer of information between the elements. An I/O device interface 215 is attached to system bus 205 in order to connect various input and output devices (e.g., keyboard, mouse, touch-screens, displays, printers, speakers, etc.) to the deal promotion system. A network interface 225 allows the computer to connect to various other devices attached to a network (e.g., network 120 of FIG. 1). A memory 230 provides volatile storage for computer software instructions 235 and data 240 used to implement methods employed by the system disclosed herein. Disk or persistent storage 245 provides non-volatile storage for computer software instructions 250 and data 255 used to implement an embodiment of the present disclosure. A central processor unit 220 is also attached to system bus 205 and provides for the execution of computer instructions.

In one embodiment, the processor routines 235 and 250 are a computer program product, including a computer readable medium (e.g., a removable storage medium such as one or more flash drives, DVDROM's, CD-ROM's, diskettes, tapes, etc.) that provides at least a portion of the software instructions for the system. A computer program product that combines routines 235 and data 240 may be installed by any suitable software installation procedure, as is well known in the art. In another embodiment, at least a portion of the software instructions may also be downloaded over a cable, communication, and/or wireless connection.

With reference now to FIG. 3, client devices, such as client devices 122, 124, 126, 128 of FIG. 1, can provide user interfaces via a presentation layer 305 to the functions of the deal promotion system services layer 310. Such interfaces can be browser-based, application-based, or both. In some embodiments, these applications can include application containers such as html clients 320, native PC applications 325, and/or native mobile apps 330. Application containers 320, 325, 330 can interface with the deal promotion system services layer 310 via the internet 335, for example, through a web server 340. In some embodiments, client devices 122, 124, 126, 128 execute one or more applications that receive html pages generated by a web server 340. In some implementations, the web server 340 page generation and transmission is supported, at least in part, by a content management system such as, for example, WordPress®.

The deal promotion system architecture 300 can include a services layer 310 that exposes a variety of discreet services accessible to authorized clients 320, 325, 330. It is through these services that information can be added to, and retrieved from, the databases found in the persistence layer 315. The services layer 310, together with the persistence layer 315, can, in part, consist of a collection of tables and data stores supporting the deal promotion system services. In some instances, services are implemented using server-side PHP code, and JavaScript code, implemented in conjunction with a content management system, such as, for example, WordPress®.

In some embodiments, a deal service 345 provides associated methods and data structures for deal creation, configuration, and management functionality, including maintaining deal availability counters. These functionalities are supported by data and data relations stored in a deal database 360.

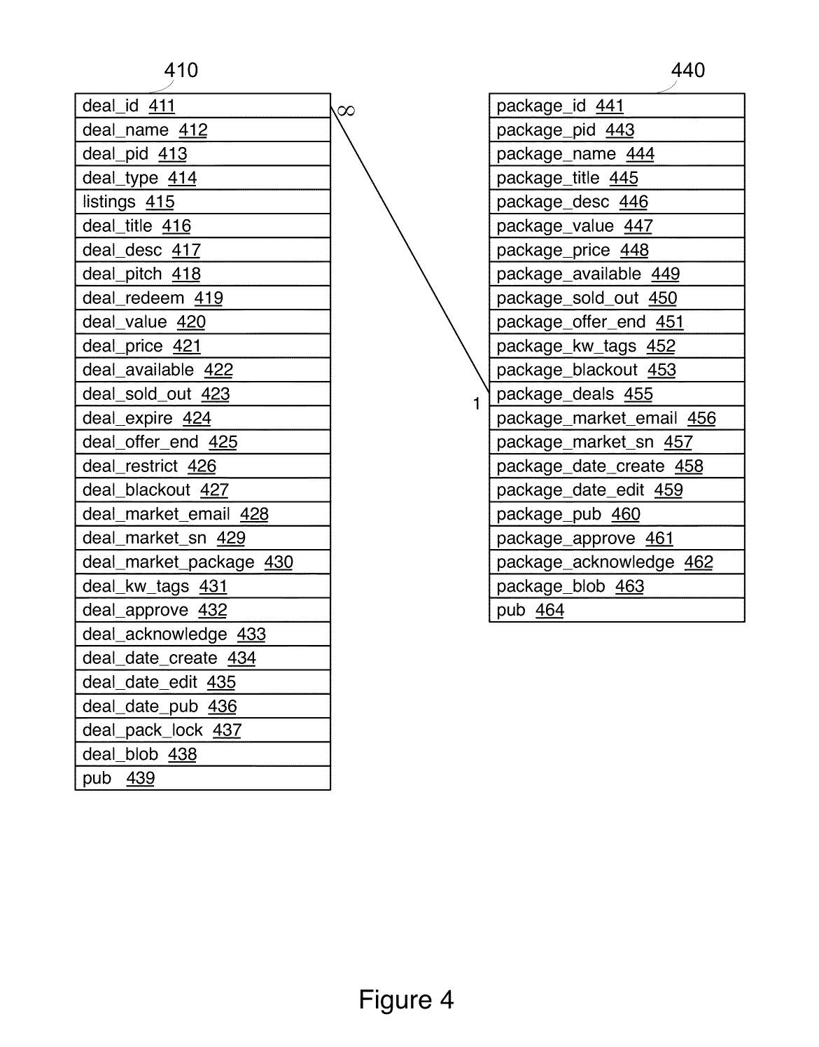

A package service 346 provides associated methods and data structures for deal package creation and configuration functionality. These functionalities are supported by data and data relations stored in the deal database 360 and a package database 361. Content and interactions between the deal database 360 and the package database 361 will be described in more detail with reference to FIG. 4 below.

A document management service 347 provides associated methods and data structures for uploading, storing, and retrieving files and documents, including binary files. Document management functionality is supported by data and data relations stored in the deal and package databases 360, 361. In some embodiments, files are stored directly in the file system with index-based file naming conventions. The document management service 347 may support binary image upload, storage and retrieval, for example, where files are uploaded, associated, and displayed with a deal, a deal package, or both. The document management service may also manage other documents, files, etc., to better facilitate creation of deals and deal packages, such as by interfacing with the deal service 345 and package service 346, as an example.

A user service 351 provides associated methods and data structures for user access and management functionality. These classes are supported by data and data relations stored in a listing owner database 362 and a deal vendor database 363. In some instances, the user service 351 implements an authentication-based roles and privileges model limiting access to the deal promotion system, limiting system functionality based, at least in part, on assigned roles, assigned privileges, or both.

A marketing service 352 provides associated methods and data structures for deal and package marketing functionality. In certain instances, the marketing service provides targeting of deals to one or more business, categories of the business, and the like. The marketing service can also provide functionality determining marketing channels for automated marketing message distribution at the occurrence of one or more trigger events. These classes are supported by data and data relations stored in a marketing database 364.

A conflict resolution service 353 provides associated methods and data structures for resolving conflicts associated with multiple deal restriction, overlapping blackout dates, over-extended offer-end date conditions, and the like. These classes are supported by data and data relations stored in the deal and package databases 360, 361. In some embodiments, the conflict resolution service 353 communicates with other services and obtains additional data used in calculations supporting conflict resolution determinations.

A publications service 354 provides associated methods and data structures for publication scheduling triggers, email channel distribution methods, and social networking channel distribution methods. These classes are supported by data and data relations stored in the marketing database 364.

A widget creation service 349 provides associated methods and data structures for selecting deals, deal packages, or both, and generating code for use in displaying deal promotion platform or system content in external environments, such as, for example, listing owner websites. The widget creation service 349 may, generate JavaScript code for insertion into a set of <div></div> tags on an external website. The JavaScript code may, for example, embed buttons for display on an external site such that an end user can select deals and deal packages. In some embodiments, the widget creation service is exposed as an application programming interface, such as a REST API, for automated creation of widget code. In certain implementations, a portion of the JavaScript code produced includes one or more unique keys associated with one or more deals, deal packages, listings, or directories. These keys can be passed to the deal promotion system or platform when a button press event associated with an embedded button is detected by an external client interface.

A message cache service 348 provides associated methods and data structures for queuing and distributing incoming and outgoing messages. The message cache service 348 may interact with and support other service, such as the deal service 345, the package service 346, the user service 351, the search service 350, and/or the document management service 347, as an example, to temporarily store information received by the services layer 310 before the information can be routed by the appropriate service to the appropriate database.

The search service 350 provides search-related functionality for the deal promotion system. One or more search indices 365 provide support for the search service 350. The indexing service 355 provides index-related and organization functionality for the deal promotion system. One or more search indices 365 provide support for the indexing service 355.

In some embodiments, some or all of the services in the services layer 310 may communicate with each other to better facilitate data organization and transfer. Similarly, some or all of the databases in the persistence layer 315 may communicate with each other to better facilitate data organization and transfer.

With reference now to FIG. 4, a block diagram 400 shows an example of a deal table 410 linked to a package table 440. The deal table 410 and the package table 440 may support various services, including the deal service 345 and the package service 346 described above in reference to FIG. 3. In some implementations, the deal database 360 described in reference to FIG. 3 includes the deal table 410, and the package database 361 includes the package table 440. In certain instances, the deal table 410, the package table 440, or both are stored in a relation database, such as a MySQL database, with support for PHP access through one or more PHP SQL libraries. A deal object or data structure can include all values in the deal table associated with a given record as identified by a the DEAL_ID 411. In this example, deal information for a deal can be retrieved by PHP-based queries such as the following:

function get_deal_info($did) {

global $db;
$promo_deals = $db−>“promo_deals”;
$dealinfosql = “select * from $promo_deals where ID = $did”;
$dealinfo = $wpdb−>get_results($dealinfosql);
if($dealinfo) {

foreach($dealinfo[0] as $key => $val) {

$dealArray[$key] = $val;

}

}
$dealArray = stripslashes_deep($dealArray);
return $dealArray;

}

Similarly, a package object or data structure can include all values in the package table associated with a given record as identified by the PACKAGE_ID 441. Package information for a deal package can be retrieved by PHP-based queries such as the following:

function get_package_info($pkid) {

global $db;
$promo_packages = $db−>“promo_packages”;
$packageinfosql = “select * from $promo_packages where
ID=$pkid”;
$packageinfo = $wpdb−>get_results($packageinfosql);
if($packageinfo) {

foreach($packageinfo[0] as $key => $val) {

$packageArray[$key] = $val;

}

}
return $packageArray;

}

Additionally or alternatively, other code retrieval functions can be used based on the type of database storing the information and the supporting access libraries. In some instances, the deal object/data structure or package object/data structure can include a subset of the values included in a given record of the respective database table.

For purposes of this application, a deal vendor can be referred to as a deal creator. Further, a listing owner can be referred to as a package creator or a deal package creator. In some instances, a business may operate as both a deal vendor and a listing owner. The deal table 410 may include information associated with a deal, for example entered into a deal promotion platform by a deal vendor. Each row in the deal table 410 may be identified by a unique DEAL_ID 411. Each row may include values for multiple deal configuration parameters including, for example, value, price, quantity available, blackout dates, etc. The package table 440 may include information associated with a deal package, for example, including multiple deals selected by a listing owner through a package creation interface provided by the deal promotion platform or system. Each row in the package table 440, may be identified by a unique PACKAGE_ID 441. Each row may include values for multiple package configuration parameters, including, for example, price, value, discount value, offer end date, blackout dates, associated deal descriptions, and the like.

In some embodiments, a package record may be associated with multiple deal records. The PACKAGE_DEALS field 455 for a record in the package table 440 can store an array of DEAL_ID values 411 that reference multiple deal records. This one-to-many relationship can be used to obtain deal information for all deal records associated with a package record. The following code can retrieve this information from a MySQL database supporting PHP access:

function get_package_deals($pkid) {

global $db;
$promo_packages = $db−>″promo_packages″;
$packageinfosql = ″SELECT ‘package deals‘ FROM
$promo_packages

WHERE ID = $pkid″;

$packageinfo = $wpdb−>get_results($packageinfosql);
if($packageinfo) {

foreach($packageinfo as $packagedeals) {

$packageDealArray =
explode(″,″,$packagedeals−>package_deals);

}

}
return $packageDealArray;

}

In addition, and alternatively, other code retrieval functions can be used based on the type of database storing the information and the supporting access libraries.

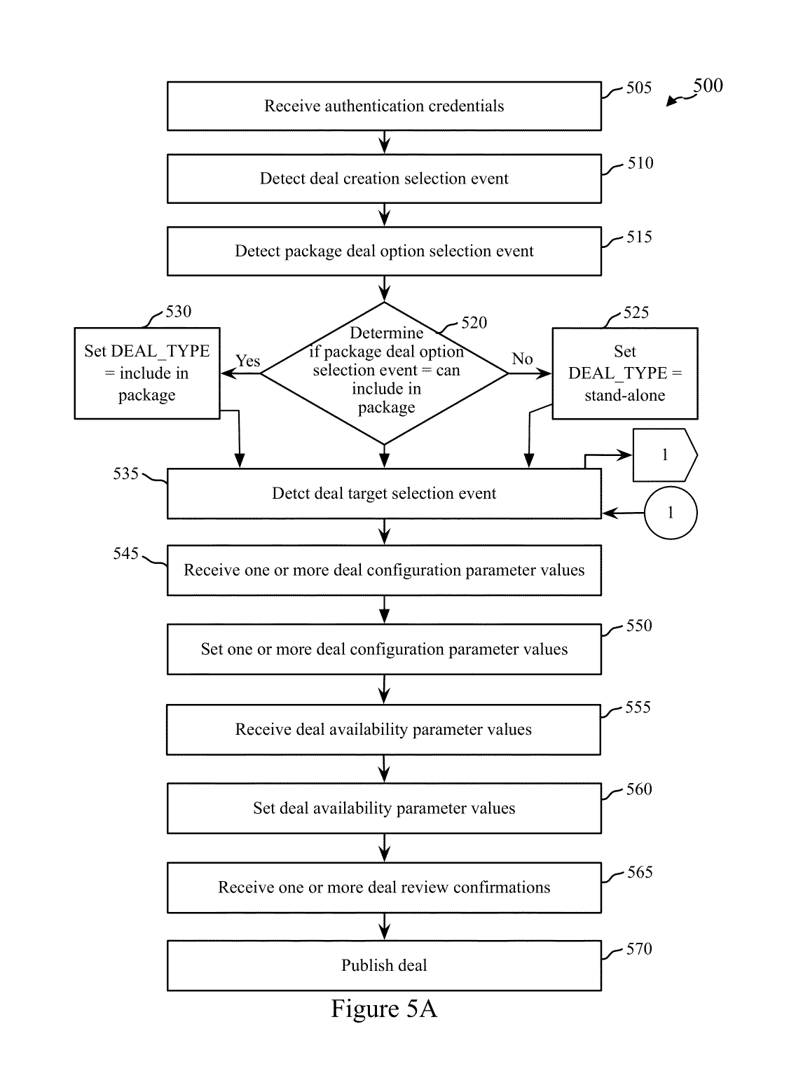

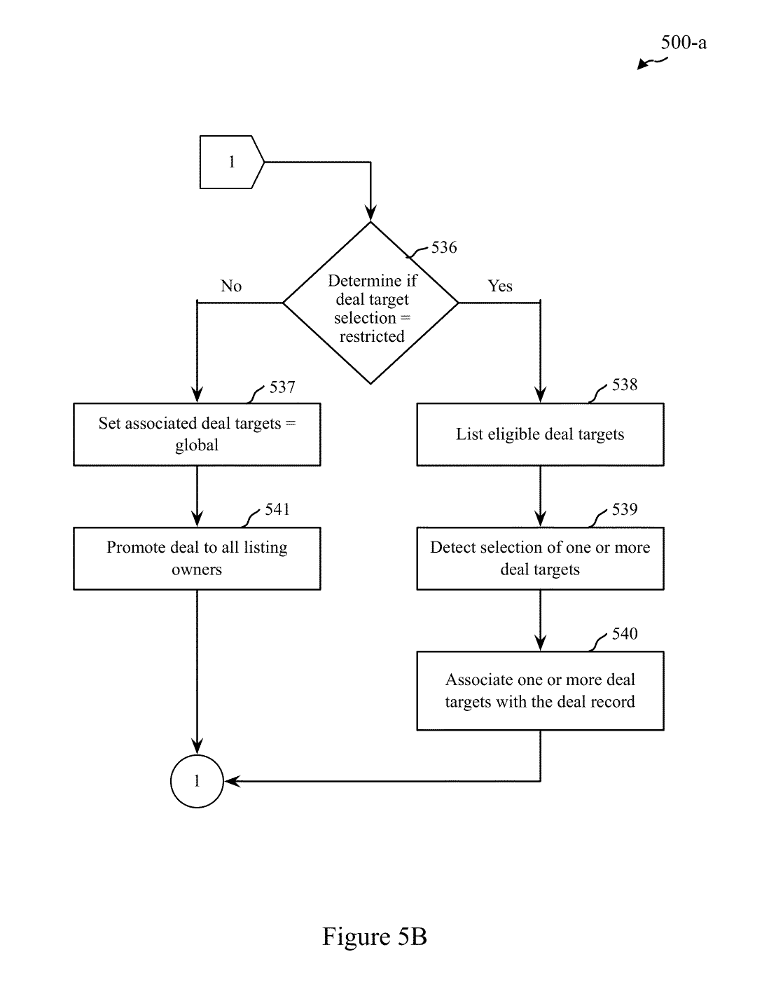

Information and values stored in different fields of the deal table 410 and the package table 440 will be described in more detail below in reference to FIGS. 5A-7.

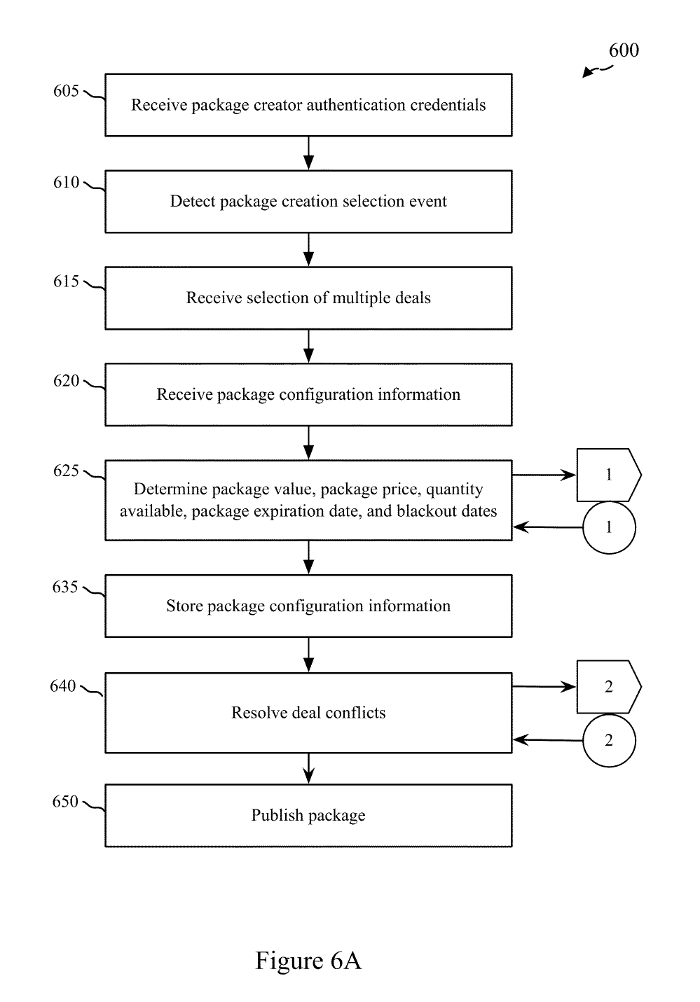

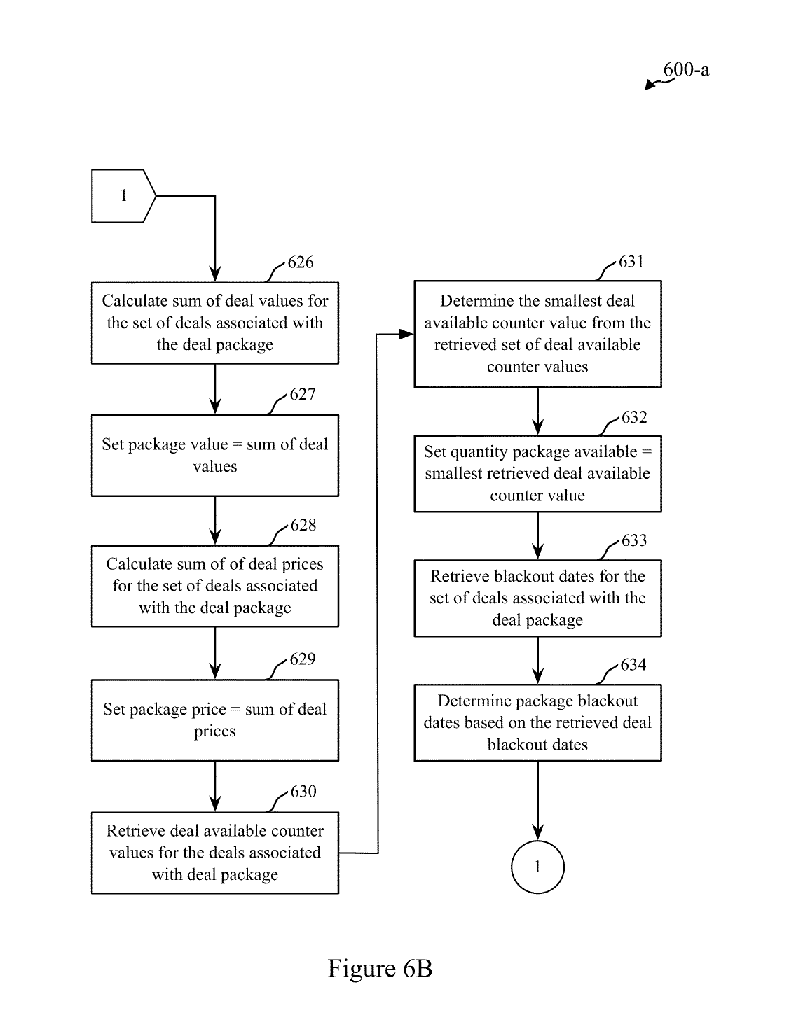

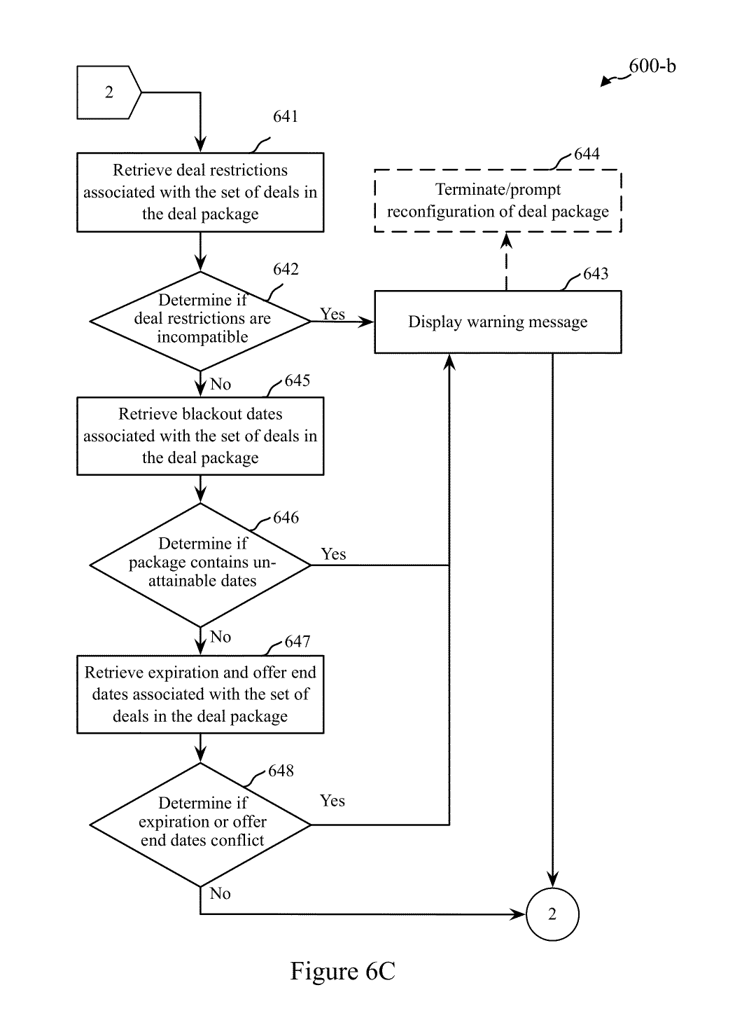

With reference now to FIG. 5A, a flow diagram 500 depicts a process for receiving deal configuration information at a deal promotion system or platform, such as system 104 described in reference to FIG. 1, system 300 described in reference to FIG. 3, or a combination of both systems. The deal promotion platform may first receive authentication credentials 505 that enable access to the deal promotion platform. In some cases, certain authentication credentials may allow the user or session access to only deal configuration functionality, whereas in other cases, the authentication credentials may grant the user or session access to broader deal promotion platform functionality, including the ability to configure deal packages. The process for configuring deal packages will be described in more detail below in reference to FIGS. 6A-6C. The authentication credentials may be received via input on a client device 102 communicated to the deal promotion platform over network 120 as described in reference to FIG. 1, for example. The user service 351 may receive the authentication credentials, and verify them against authentication credentials stored in the listing owner database, the deal vendor database, or both 362, 363. In some embodiments, authentication is performed in conjunction with an external system, such as LDAP, active directory, web service based authentication, and the like.

Once the authentication credentials are verified, the deal promotion platform may detect an event associated with the initiation of deal creation 510. The deal service 345 may create a deal record in the deal table 410. Each record in the deal table 410 may be identified by a unique DEAL_ID value set at the time the record is created by the deal service 345 or by a sequence generation function of the database 360. The deal record may be associated with one or more records in a listing owner database (not shown). Associated identifiers for records in the listing owner database may be stored as an array in the DEAL_PID field 413.

At block 515, a package deal option selection event may be detected. In certain instances, the selection event sets a boolean flag value indicating whether a deal may be promoted outside of a deal package, or whether a deal may be promoted in a deal package. In some implementations, one of the boolean values indicates that the deal must be included in a deal package to be promoted, and therefore may not be promoted as a stand-alone deal. In addition, and alternatively, one of the boolean values may indicate the deal may only be promoted as a stand-alone deal and may not be included in a deal package.

At block 520, the deal promotion platform may then determine if the package deal option selection event indicates that the deal may be included in a deal package. If it is determined that the deal is to be a stand-alone deal 525, the DEAL TYPE field 414 for the deal record may be set to the value representing a stand-alone deal. If it is determined that the deal is to be included in a deal package 530, the DEAL TYPE field 414 for the deal record may be set to the value representing package inclusion.

At block 535, process 500 may then proceed to detect a deal target selection event 535. The deal target selection event may indicate how the deal will be promoted internally to package creators within the deal promotion platform. In some embodiments, the deal target selection may indicate whether other businesses or listing owners can discover, access, or use the deal for deal packaging. For example, if a certain deal vendor wishes to only offer a certain deal, such as a deal with a deep discount, to one or only a few select businesses, the deal vendor may choose to only target the one or select few businesses for internal marketing and deal availability. In this way, a deal creator may have more flexibility in offering deals of varying discounts to different businesses.

In other cases, a user of the system may operate as both an entity that offers deals, and an entity that offers deal packages. For example when such a dual-functioning entity wants to create a deal for use only in its own deal packages, the dual-functioning entity, when logged into the deal promotion platform as a deal creator, may choose to target their corresponding package creator entity as the sole target of the deal. In this way, a dual-functioning entity can deeply discount a deal for services provided by that entity without offering that same discount to other package creators.

Process 500 may then proceed to sub-process 1, which is represented as process 500-a, as to be described in reference to FIG. 5B. It may first be determined if the deal target selection indicates a restricted target marketing selection 536. In some cases where a selection event is associated with a user interface control, an option for either restricted targeted marketing or global marketing may be displayed. If the deal target selection is not a restricted target marketing selection, the deal promotion platform may set the associated deal targets to a value representing all eligible listing owners 537. In some implementations, a null value stored in the LISTINGS 415 field for the record can represent all eligible listing owners. The deal promotion platform may then promote the deal to all eligible listing owners 541 by, for example, displaying the deal as an available deal for packaging in response to certain search requests by listing owners, broadcasting a message to all listing owners, displaying in-platform deal advertising to listing owners, and the like.

If it is determined that the deal target selection indicates a restricted target marketing selection, the deal promotion platform may display a list of the eligible listing owners in the deal promotion platform 538. At blocks 539 and 540, the selection of one or more listing owners may be detected, then associated with the deal record. In some instances, a LISTINGS array 415 is populated with each of the unique identifiers associated with the selected listing owners as retrieved from a listing owner database 362. In other embodiments, other or different target options may be presented, selected, or both. The deal promotion platform may then promote the deal to all targeted listing owners by, for example, displaying the deal as an available deal for packaging in response to certain search requests by targeted listing owners, broadcasting a message to targeted listing owners, displaying in-platform deal advertising to targeted listing owners, and the like. Process 500-a may then transition back to process 500.

The deal service 345 of the deal promotion platform may receive and store one or more deal configuration parameter values 545, 550 in a deal table 410. The deal configuration parameters may include:

an internal deal name stored as a text value 412;
a deal title stored as a text value 416;
a deal description stored as a text value 417
a deal pitch directed to listings owners stored as a text value 418;
deal redemption instructions stored as at text value 419;
retail price of the deal before discounting as a decimal value 420;
price of the deal after discounting 421 stored as a decimal value, which may also be received, displayed, or both as a discount percentage of the retail price;
a quantity value stored as an integer 422 indicating how many redemption vouchers for the particular deal will be generated;
a deal expiration date stored as a date 424; and
tags and keywords stored as an array 431 identifying the deal for search categorization. In some cases, one or more redemption vouchers may also be referred to as deal redemption indicia, a deal redemption token, a deal token, a deal redemption code, coupon, or the like. In some instances, the tags and keywords are retrieved and integrated into the search index 365, such that when a search is performed via the search service 350, the deal information stored in the table 410 may be retrieved through keyword or tag-based searches.

The deal promotion platform may then receive further deal information concerning deal offering limitations, deal availability, or both 555. The deal limitations may include one or more deal restrictions stored as an array of boolean selection flags 426. These restrictions may include, for example, that the deal may only be offered with certain other types of deals in a deal package, that the deal may not be combined with other deals or types of deals, and the like. The deal limitations may further include deal blackout dates stored as an array of dates 427 indicating when the deal will not be available, and a deal offer end date stored as a date 425 indicating the last date the deal will be offered on the deal promotion platform. This deal availability information may be set 560 by the deal promotion platform, for example, in a deal table 410.

Prior to publication of a deal, the deal promotion platform may receive one or more deal review confirmations 565 such as by requesting approval of the configured deal, acknowledgement of deal terms as they relate to the deal promotion within the deal promotion platform, or both. Once the one or more deal review confirmations for the deal have been received, the deal service 345 may set one or more confirmation values, such as a DEAL APPROVAL boolean field 432 and a DEAL ACKNOWLEDGE boolean field 433 to true. In some cases, by accepting the terms for offering a deal, the deal becomes irrevocable such that if the deal is included in a deal package, the package owner can commit to honor a given price and availability level for the deal. A deal may be may then be published 570, such as, for example, being made available for packaging within the deal promotion platform. Each deal record may include a boolean field 439 that indicates a deal has been published. In the case where a deal has been set to be a stand-alone deal, publishing the deal 570 may include publishing the deal to consumers for purchase, making the deal available for inclusion in a widget for external display, or both.

In some embodiments, other information related to a deal may be received by the deal service 345. This information, for example, may include pictures to be used for advertising, other details of the deal, etc. This information may be stored as a binary large object 438 associated with the deal record. In some embodiments, the date the deal is created, the most recent date the deal was edited, and the first date the deal was published may be stored as date values 434, 435, 436 in the deal record.

With reference now to FIG. 6A, a flow diagram 600 depicts a process for receiving package configuration information at a deal promotion system or platform, such as system 104 described in reference to FIG. 1 and/or system 300 described in reference to FIG. 3. The deal promotion platform may first receive package creator authentication credentials 605 enabling access to the deal promotion platform. In some cases, certain authentication credentials may allow the user or session access to only package configuration functionality, whereas in other cases, the authentication credentials may grant the user or session access to broader deal promotion platform functionality, including the ability to configure deals. The package creator authentication credentials may be received via input on a client device 102 communicated to the deal promotion platform over network 120 as described in reference to FIG. 1, for example. In addition, and alternatively, the package creator authentication credentials can be received as arguments via an exposed application programming interface such as, for example, a REST based interface. The user service 351 may receive the package creator authentication credentials, and authenticate them against authentication credentials stored in the listing owner database 362, the deal vendor database 363 or both. In some embodiments, authentication is performed in conjunction with an external system, such as LDAP, active directory, web service based authentication, and the like.

Once the authentication credentials are verified, the deal promotion platform may detect an event associated with the initiation of package creation 610. The package service 346 may create a package record in the package table 440. Each record in the package table 440 may be identified by a unique PACKAGE_ID value 441 set at the time the record is created by the deal service 345 or by a sequence generation function of the database 360. The package record may be associated with one or more records in a listing owner database (not shown). Associated identifiers for records in the listing owner database may be stored as an array in the PACKAGE_PID field 443. The package service 346 may then detect selection of multiple deals to be included in a deal package 615. The package service 346 may retrieve and associate the unique identifiers for each selected deal with the package record. In some implementations, a PACKAGE_DEALs field 455 of the package table 440 may store a set of DEAL_ID values 411 as an array, as described above in reference to FIG. 4.

The deal promotion platform through the package service 346 may receive package configuration information 620. The package configuration information may include:

an internal package name stored as text 444;
a package title stored as a text value 445;
a package description stored as a text value 446; and
tags and keywords stored as an array 452 identifying the package for search categorization. In some instances, the tags and keywords are retrieved and integrated into the search index 365, such that when a search is performed via the search service 350, the package information stored in the table 440 may be retrieved through keyword or tag-based searches.

The deal promotion platform via the package service 346 may then determine the package value, package price, the quantity available for the deal package, the package offer end date, and package blackout dates 625. The process 600-a for determining these values 625 will be described in reference to FIG. 6B, as indicated by the block arrow designated “1” in FIG. 6A.

The package service 346 may calculate the sum of deal values of the set of deals associated with the deal package by retrieving the values stored in the DEAL VALUE field 420 in the set of associated deal records 626. The package service 346 may then set the value stored in the PACKAGE VALUE field 447 of the package table 440 to the calculated sum of the deal values 627. Next, the package service 346 may calculate the sum of the deal prices for the set of deals associated with the deal package by retrieving the values stored in the DEAL PRICE field 421 in the set of associated deal records 628. The package service 346 may then set the value stored in the PACKAGE PRICE field 448 of the package table 440 to the calculated sum of the deal prices 629.

In some embodiments, the relationship of the price of the package to the value of the deal package may additionally, or alternatively, be expressed as a discount value. This discount value may be relative to the entire deal package, and thus may conceal individual deal discounts. This may be particularly useful when a deal vendor, for example, wishes to offer a deal at a deep discount, but does not want consumers to know this information.

The package service 346 may then retrieve the deal available counter value stored in the DEAL_AVAILABLE field 422 of each deal associated with the package 630. In some cases, the deal available counter value may also be referred to as a remaining available deal count. The smallest number of deals available for the deals in the deal package may then be determined 631 from the retrieved set of deal available counter values. The PACKAGE_AVAILABLE field 449 may then be set to the smallest retrieved deal available counter value 632. Each time a deal redemption code is distributed as part of a package transaction or stand-alone deal transaction, the value in the DEAL_AVAILABLE field 422 associated with the deal record will automatically decrement by one. As a result, each time a deal redemption code is distributed, the number of available deals is automatically updated across all deal packages and stand-alone deal offerings.

In some embodiments, once the DEAL_AVAILABLE field 422 of a deal record reaches zero, a DEAL_SOLD_OUT flag 423 is automatically set to indicate that the deal is unavailable for inclusion in a deal package. This may result in preventing the display of the deal during the package creation process, exclusion of the deal from deal packages where the deal was included previously, retraction of deal packages that include the deal from any listings to consumers of available deal packages, and the like. This may prevent overselling of a deal across the deal promotion platform without requiring additional monitoring by a deal vendor or listing owner, for example.

In some embodiments, every time a deal package is accepted, the package service 346 may decrement the PACKAGE_AVAILABLE field 449 stored in the package record. To prevent overselling of the package, once the PACKAGE_AVAILABLE field 449 of a package record equals zero, a PACKAGE_SOLD_OUT flag 450 of the same package record may be set. In some cases, if the PACKAGE_SOLD_OUT flag 450 is set, the package service 346 may remove the package and/or make the package un-available to select in the deal promotion platform.

In certain instances, blackout dates for each of the deals associated with the deal package may be retrieved 633. For example, the package service 346 may retrieve the value stored in the DEAL_BLACKOUT field 427 for the set of deal records associated with the deal package. The blackout dates for the deal package may then be determined based on the retrieved deal blackout dates 634. The determined package blackout dates may then be stored in the PACKAGE_BLACKOUT field 453 of the package table 440. In some embodiments, a package blackout date may be a date where none of the deals in the deal package are valid, e.g., a date that aligns with blackout dates for all the deals in the deal package. In other cases, other metrics may be used to determine package blackout dates. For example a threshold percentage of blackout dates may be set such that only if a certain number, e.g., a percentage, of the deals in the deal package have a blackout date falling on a particular date, will that date be set as a package blackout date.

Process 600-a may then return to process 600 of FIG. 6, where the package configuration information may be stored 435. In some cases, as described above, one or more values may be stored in other blocks as described above, such as in block 620, 625, or both.

Next, deal conflicts may be resolved 640. The process 600-b of resolving conflicts 640 will be described in reference to FIG. 6C, as indicated by the block arrow designated “2” in FIG. 6A. Deal conflicts may be resolved by the conflict resolution service 353, which can retrieve deal and package information from one or more deal and package tables 410, 440 from the deal and package databases 360, 361.

First, the conflict resolution service 353 may retrieve deal restrictions from the deal tables 410 associated with the set of deals in the deal package 641. The conflict resolution service 353 may then determine if any deal restrictions are incompatible 642 based on rules specific to each type of deal restriction. If any deal restrictions are determined to be incompatible, such as limits on packaging deals with other deals, etc., a warning message may be displayed 643. The warning message may indicate that packaging the selected deals may result in potentially less value to a consumer, may be very restrictive, etc. In certain cases, if deal restriction conflicts render a deal package completely without value, another message may be displayed directing the user to terminate the deal package or reconfigure the deal package 644.

If the deal restrictions are determined to be compatible, blackout dates from the deals in the deal package may then be retrieved 645. For example, the value of the DEAL_BLACKOUT field for each deal record associated with the deal package may be retrieved by accessing the deal database 360. The conflict resolution service 353 may then determine if the deal package contains any un-attainable or blackout dates 646. If the deal package does contain blackout dates, one or more warning messages may be displayed 643, 644, as described above. In some cases, a threshold number or percentage of un-attainable dates in the deal package may be set such that a warning message 643, 644 is only displayed if the threshold is exceeded. In some cases, this threshold may be equal to 20, 30, 40, 50 percent, and so on.

If the deal package does not contain any or above a threshold amount of unattainable dates, the expiration and offer end dates of each of the deals in the deal package may be retrieved 647. For example, the value of the DEAL EXPIRE field 424 and the DEAL_OFFER_END field 425 for each deal record associated with the deal package may be retrieved by accessing the deal database 360. Next, it may be determined if any of the expiration or offer end dates of the deals conflict 648. If it is determined that a conflict exists, one or more warning messages may be displayed 643, 644 as described above. For example, a conflict may exist if a deal offer end date is set less than a predetermined number of days from the creation date of the deal package, such as 15, 30, 45 days or less. In other cases, a conflict may be determined if a deal expiration date is within a predetermined number of days of the creation date of the deal package. Other metrics may be used to determine if a conflict exists. In some embodiments, the following code sets the PACKAGE_OFFER_END value for the package record:

function getPackageExpire($package_id) {

global $db;
$packageExpire = strtotime(″0000-00-00″);
$packageArray = get_package_info($package_id);
foreach($packageArray as $key => $value) {

if($key == ″ID″) {

$key = ″package_ID″;

}
$$key = $value;

}
$the_package_deals = explode(″,″, $package_deals);
foreach($the_package_deals as $the_deal) {

$get_the_deal = $wpdb−>get_results(″SELECT * FROM
‘promo_deals‘

WHERE ‘ID‘ = ′$the_deal′ ″);

foreach($get_the_deal as $deal) {

$deal_expire_offer =
strtotime($deal−>deal_expire_offer);

}
if($packageExpire == strtotime(″0000-00-00″)) {

$packageExpire = $deal_expire_offer;

} elseif($deal_expire_offer < $packageExpire) {

$packageExpire = $deal_expire_offer;

}

}
return date(″Y-m-d″, $packageExpire);

}

If a conflict is not determined to exist, process 600-b may end and return to process 600. Once all the package information has been received and values determined, the deal promotion platform may request confirmation accepting the package parameters as entered, such as by requesting approval of the completed deal package. Once approval for the deal package has been received, the package service 346 may set a PACKAGE APPROVAL boolean field 461 in the package table 440 to indicate the deal package has been approved. Once the deal package is approved, the deal promotion platform may request acknowledgment of the terms of offering the deal package, and once received, the package service 346 may set the PACKAGE_ACKNOWLEDGE boolean field 462 to indicate acceptance of the terms. In some cases, by accepting the terms for offering a deal package, the deal package becomes un-revocable. A deal package may be may then be published 650. Publishing the deal package 650 may include publishing the deal package to consumers for purchase, making the deal available for inclusion in a widget for external display, or both. Each package table 440 may include a boolean field PUB 464 that indicates that the deal package has been published.

In some embodiments, the first time a deal is confirmed to be in a deal package, a DEAL_PACK_LOCK field 437 of the deal record may be set with the date the deal package is confirmed. This may “lock” the deal, preventing any modification of the deal parameters by a deal vendor after the lock date. The lock field 437 may be an additional or alternative way to ensure that a deal cannot be modified once included in a deal package.

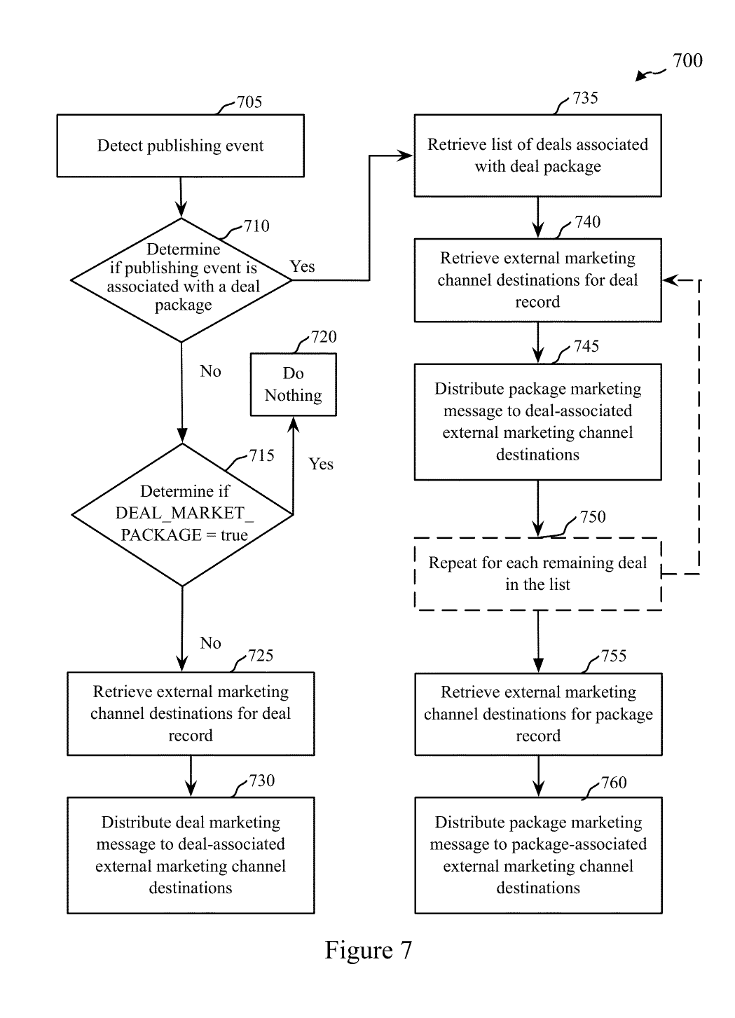

With reference now to FIG. 7, a process 700 for publishing a deal, a deal package, or both is shown. First, the deal promotion platform via the publication service 354 may detect a publishing event at block 705. The publishing event can include, for example, a publishing event internal to the deal promotion platform, such as when a deal is confirmed and then published at block 570 described in reference to FIG. 5A or when a deal package is published at block 650 described in reference to FIG. 6A. The publication service 354 may then determine if the publishing event is associated with a deal package at block 710. If it is determined that the publishing event is not associated with a deal package, e.g., it is associated with a standalone deal, the publication service may then determine if the DEAL_MARKET_PACKAGE flag 430 of the deal record is set to true. The DEAL_MARKET_PACKAGE flag 430 being set to true may enable transmission of one or more email marketing messages upon publication of a deal package. Accordingly, because the publishing event was determined not to be associated with a deal package, the publication service 354 may do nothing at block 720 until such time as a package publish event occurs where the deal package is associated with the deal. However, if the DEAL_MARKET_PACKAGE flag 430 is set to false, the publication service 354 may retrieve external marketing channel information and proceed with the marketing distribution process.

In some implementations, each deal record may contain a list of marketing channel destinations including an array of associated email addresses 428 and array of associated social networking contacts 429 referencing records stored in the marketing database 364. The publication service 354, after retrieving the marketing channel destinations, may distribute a deal marketing message to the deal-associated marketing channel destinations stored in fields 428, 429 at block 730. The deal marketing message may include any of a number of deal configuration parameters as described above.

If the publication service 354 determines that the publishing event is associated with a deal package, process 700 may proceed to block 735, where the publication service 354 may then retrieve a list of deals associated with the deal package. The list of deals may, for example, be retrieved from the PACKAGE_DEALS field 455 stored in the package record. The publication service 354 may then retrieve external marketing channel destinations for the deal record at block 740 in a similar way as described above for block 725. The publication service 354 may then distribute a package marketing message to the deal-associated external marketing channel destinations at block 745. The package marketing message may include any of a number of deal configuration parameters, package configuration parameters, or both as described above, to better market the deal package.

At block 750, the publication service 354 may repeat the process of blocks 740 and 745 for each remaining deal on the list of deals retrieved at block 730. Once a package marketing message has been distributed to one or more external marketing channel destination of the deals associated with the deal package, the publication service 354 may retrieve external marketing channel destinations for the package record at block 755.

In some implementations, each package record may contain a list of marketing channel destinations including an array of associated email addresses 456 and array of associated social networking contacts 457 referencing records stored in the marketing database 364. The publication service 354, after retrieving the marketing channel destinations, may distribute a package marketing message to the package-associated marketing channel destinations stored in fields 456, 457 at block 760. The package marketing message to package-associated external marketing channel destinations may include any of a number of deal configuration parameters, package configuration parameters, or both as described above to better market the deal package.

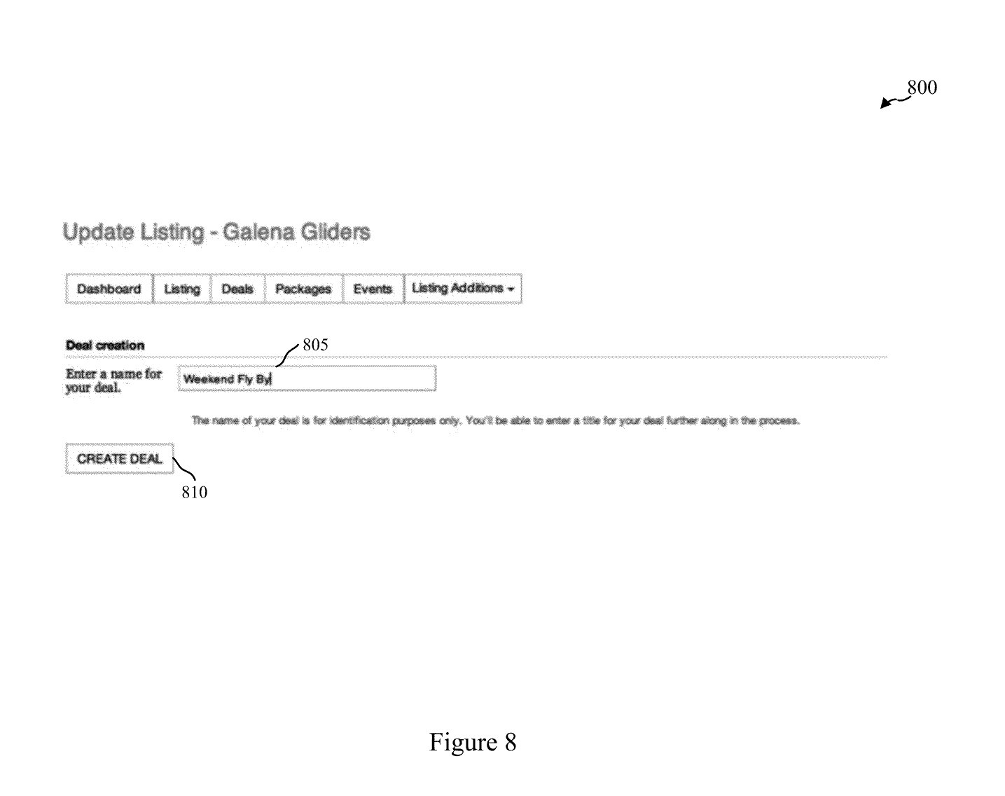

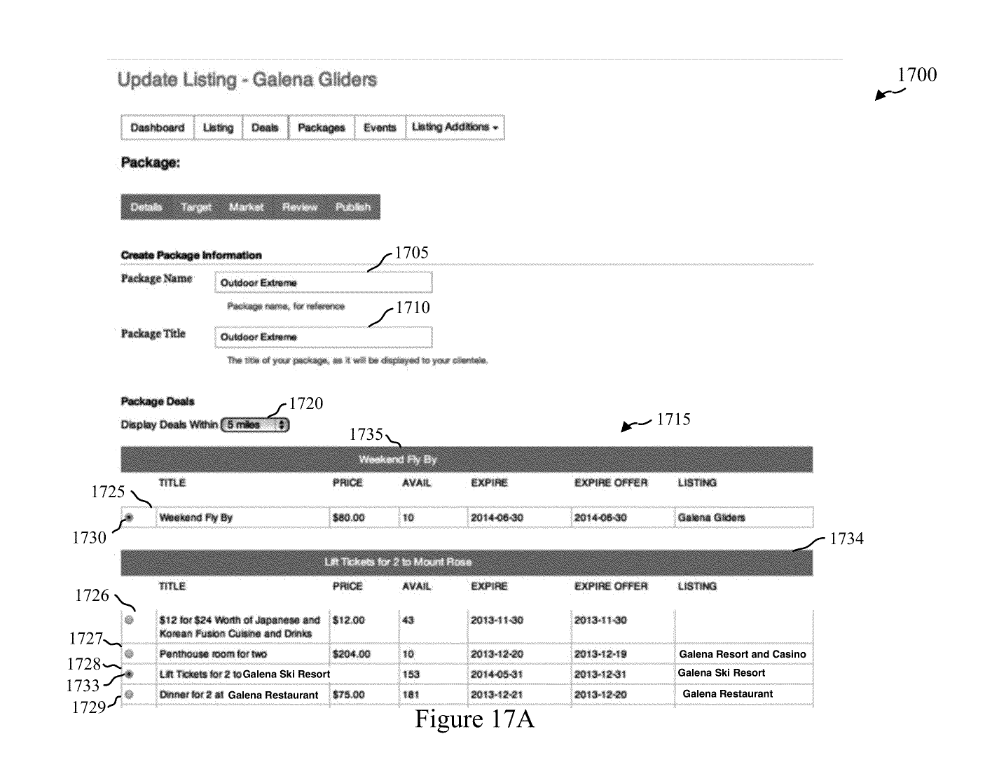

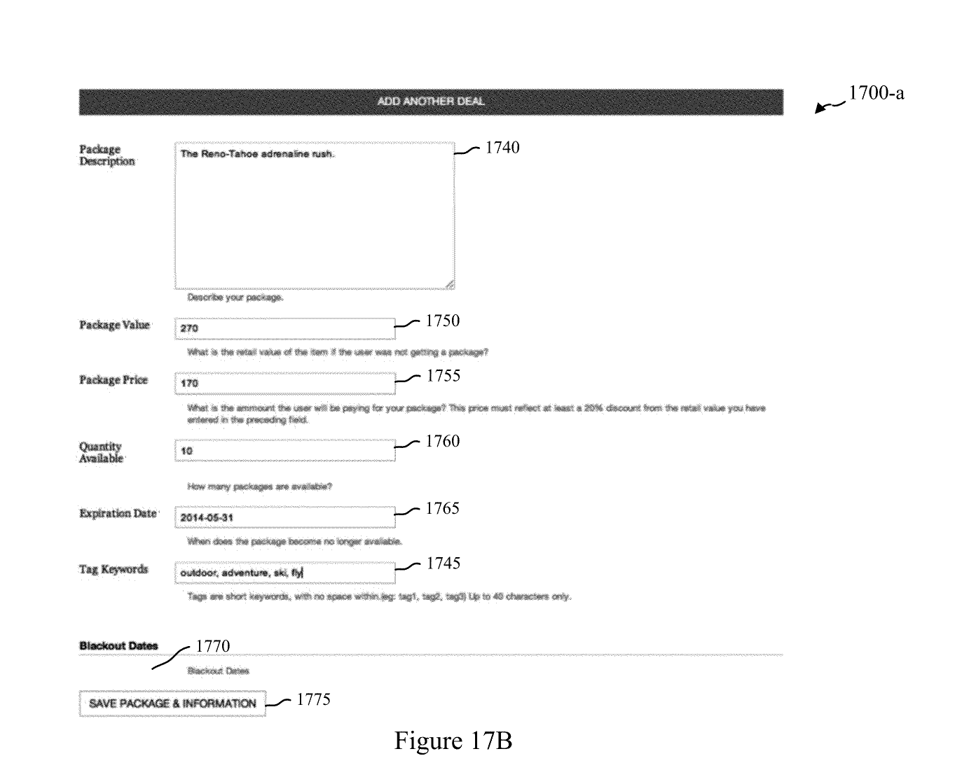

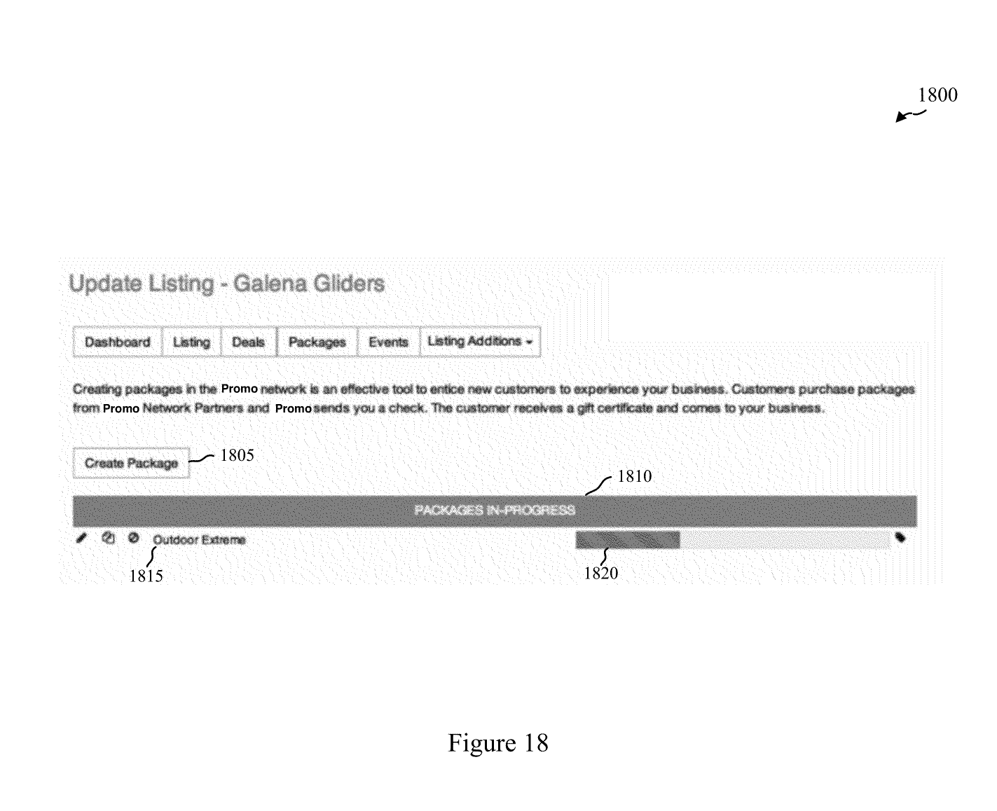

With reference now to FIGS. 8-18, an example of a graphical user interface implementing a deal promotion platform is shown. In some embodiments, the following description with reference to FIGS. 8-16 may correspond to process 500 and 500-a described in reference to FIGS. 5A and 5B for configuring a deal. The description with reference to FIGS. 17A-18 may correspond to process 600, 600-a, and/or 600-b described in reference to FIGS. 6A, 6B, and/or 6C for configuring a deal package. Once a user enters authentication credentials, such as credentials that allow configuration of one or more deals, and those authentication credentials are confirmed, screen 800 described in reference to FIG. 8 may be displayed prompting the use to enter a name for a deal at field 805. Once a name is entered, such as “Weekend Fly By,” an option to create the deal 810 may be selected.

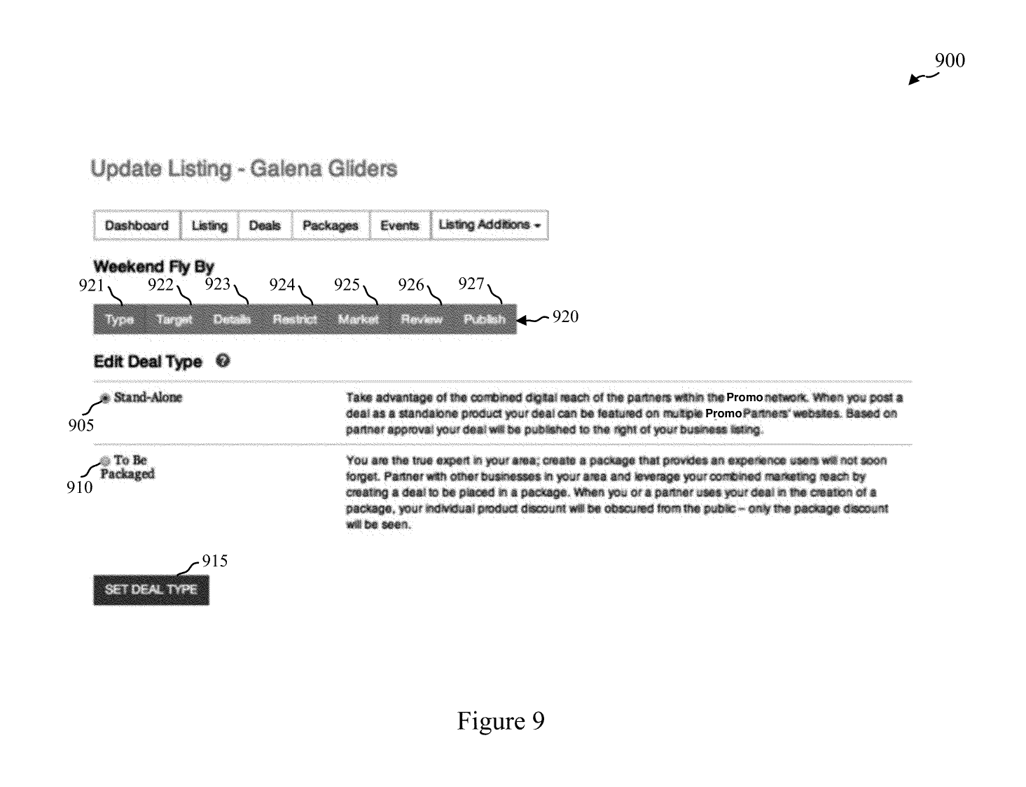

With reference to FIG. 9, screen 900 may then be displayed. A user can select a stand-alone deal option 905, which will allow the deal to be published without inclusion in a deal package, or a to be packaged option 910, that may require that the deal be included in a deal package before being published externally. An option to set deal type 915 may be selected to confirm and save the deal type selection. Screen 900 may also show a deal tool bar 920, with options to select a deal type 921, a deal target 922, deal details 923, deal restrictions 924, deal marketing 925, deal review 926, or a deal publish option 927. Selecting deal type 921 will display screen 900. The rest of the options in the deal tool bar 920 will be described in turn below.

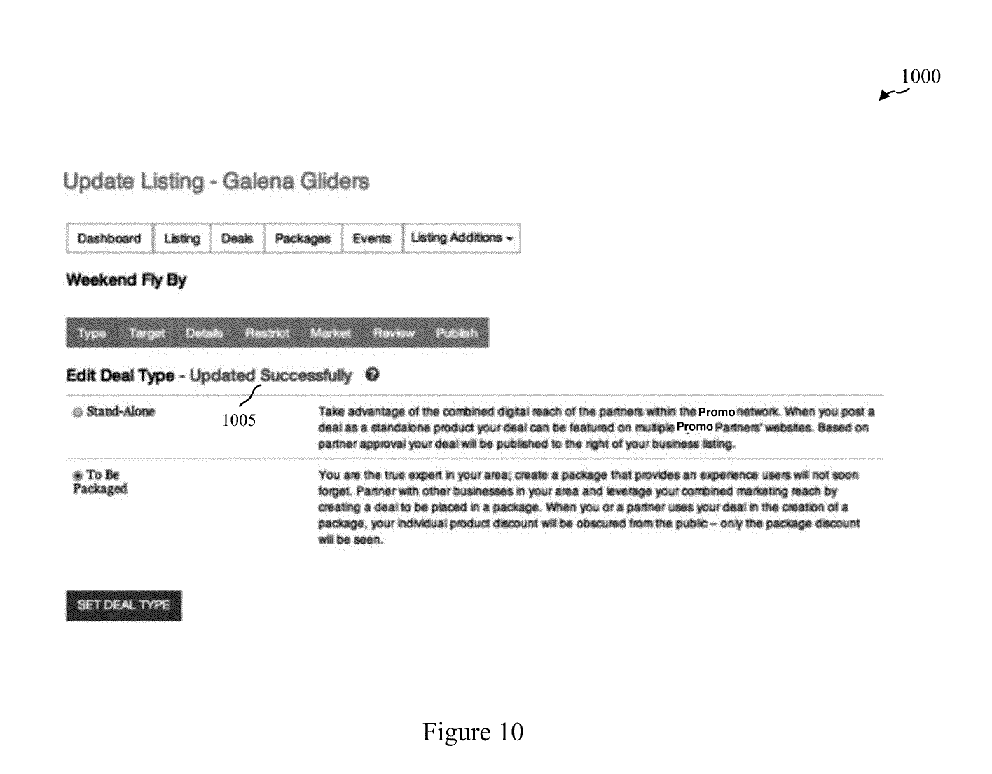

With reference to FIG. 10, screen 1000 displays a similar view as screen 900, but with an update indication 1005 that the deal type has been updated successfully. Screen 1000 may be displayed after a user selects the set deal type option 915 described in reference to FIG. 9.

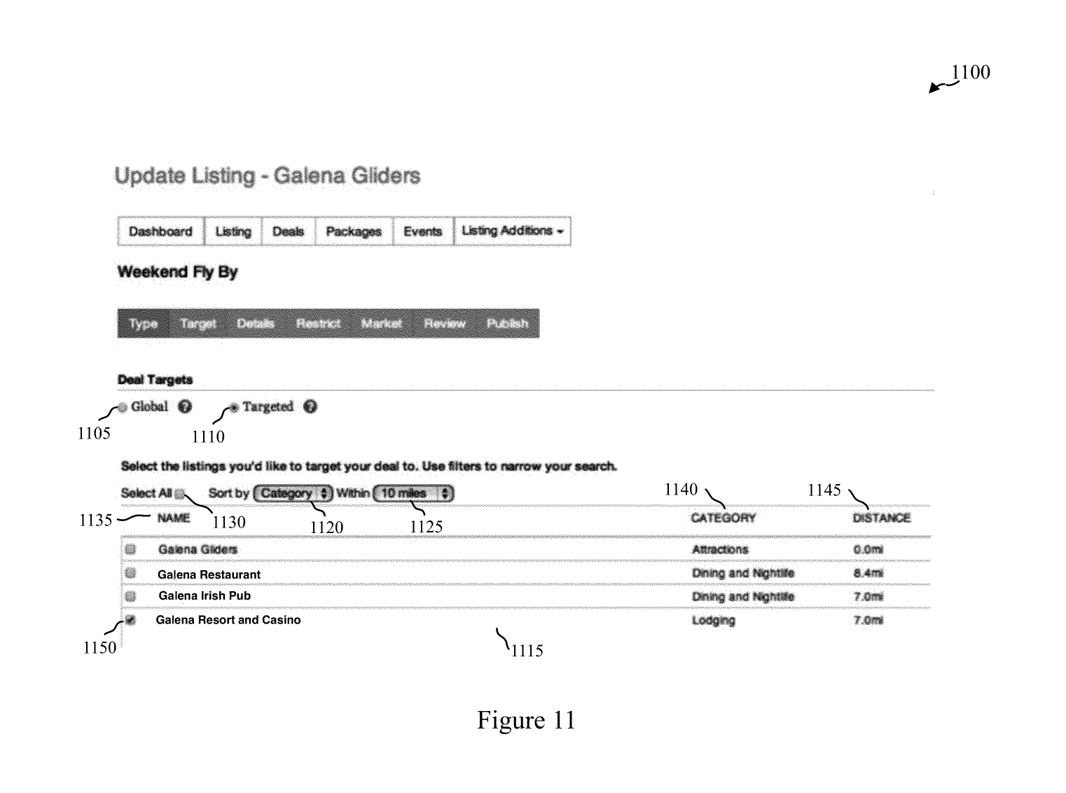

With reference to FIG. 11, screen 1100 displays multiple deal target options. FIG. 11 may be displayed after a user selects the deal target option 922 described in reference to FIG. 9. A deal target global option 1105 or a deal target targeted option 1110 may be selected. The choice of one of these options 1105, 1110 may set the deal type field 414 in the respective deal table 410 as described above in reference to FIG. 4. If the global option 1105 is selected, no further targeting information is requested from the user. If the targeted option 1110 is selected, a list of available deal targets, such as target businesses 1115 for marketing the deal package internally in the deal promotion platform is displayed. The list 1115 may be further sorted by a category option 1120, a distance within option 1125, or both. The user may also be presented with and select a select all option 1130. The target businesses list 1115 may display information of available businesses for internal deal marketing or pitching, such as name 1135, business category 1140, and distance from the deal vendor's location 1145 stored in the deal promotion platform. Each available business may be selected via a toggle 1150. In this example, the “Galena Resort and Casino” has been selected via toggle 1150. The deal target information may be saved to deal database 360 via a save changes option (not shown).

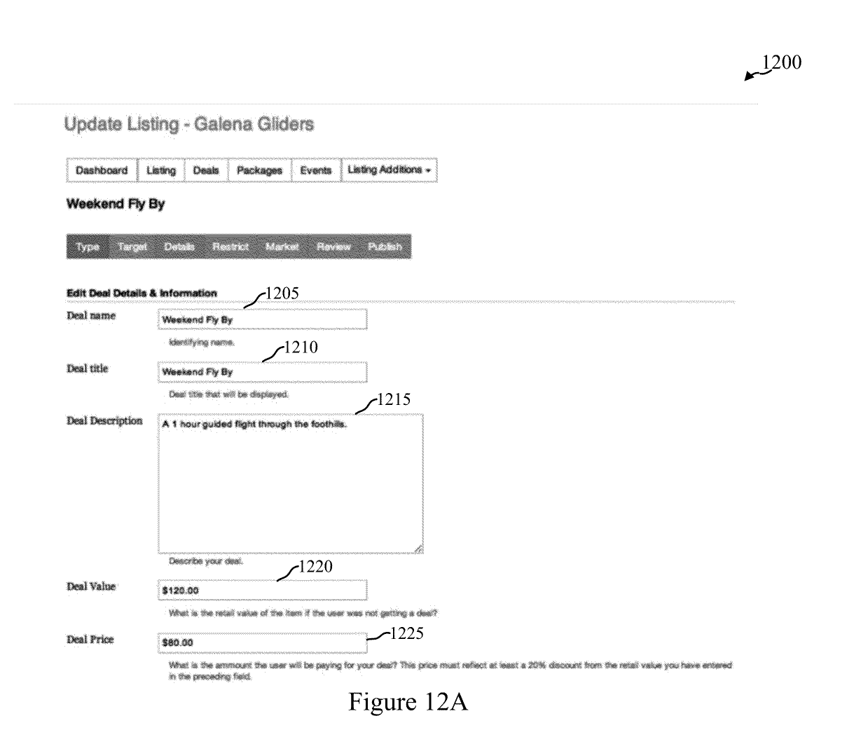

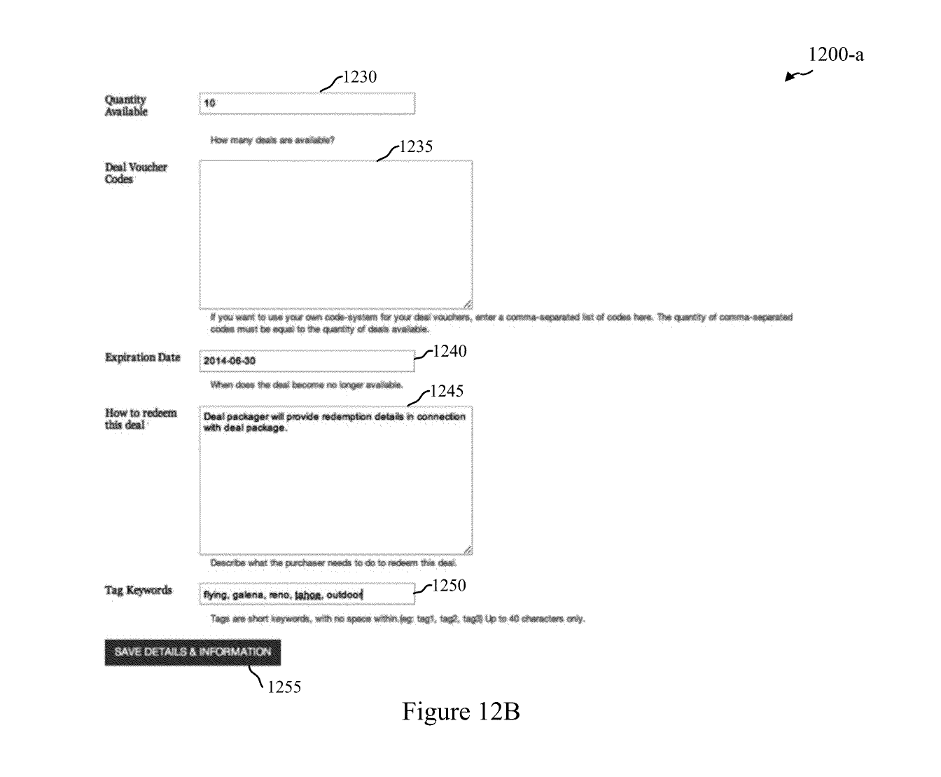

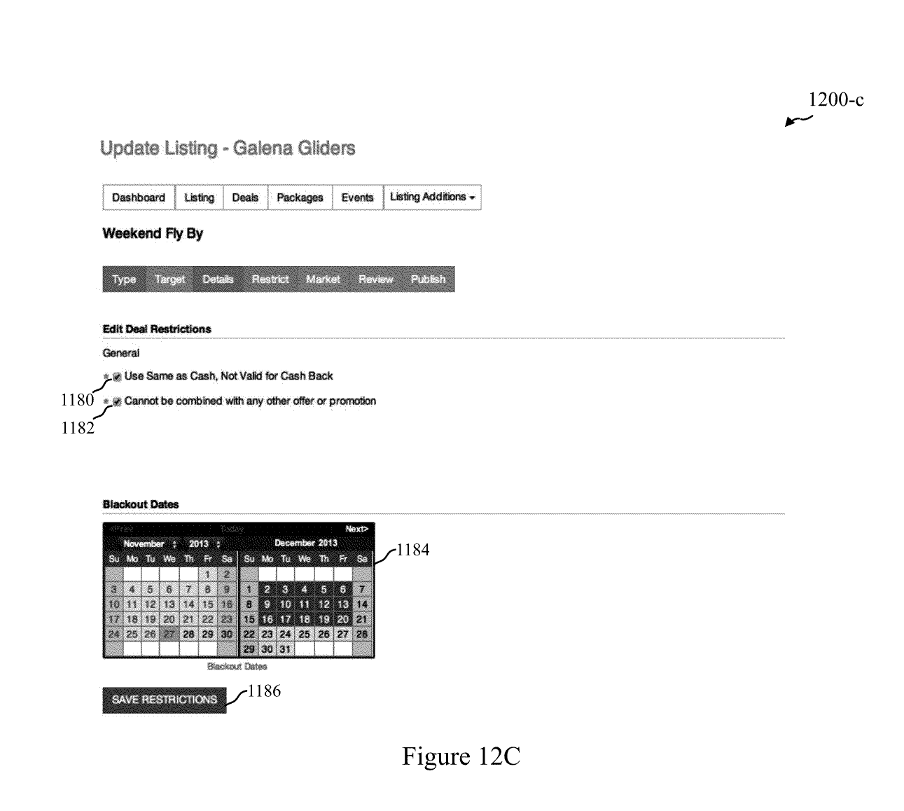

With reference to FIG. 12A-12B, the user may select the deal details option 923 described in reference to FIG. 9, whereupon screens 1200, 1200-a may be displayed. Screen 1200 may present multiple options to enter details about the deal offering, such as a deal name text field 1205 (for internal identification), a deal title text field 1210 (the title that will be displayed), a deal description text field 1215, a deal value field 1220 (retail value of the deal), and a deal price field 1225 (actual offered deal price). Screen 1200-a, which may be a continuation of screen 1200-a, may display further deal detail options fields, such as a quantity available field 1230, a deal voucher codes field 1235, an expiration date field 1240, a how to redeem field 1245, and a tag keywords field 1250. Once entered, these fields may populate the deal name 412, deal title 416, deal description 417, deal redeem 419, deal value 420, deal price 421, deal available 422, deal expire 424, and deal keywords 431 values in the respective deal record, as described above in reference to FIG. 4. At any point in entering the deal information, a user may select the save details and information option 1255, whereby the information will be stored into the respective locations in the deal record.

With reference to FIG. 12C, the user may select the deal restrict option 924 described in reference to FIG. 9, whereupon screen 1200-c may be displayed. Screen 1200-c may present multiple controls for selecting one or more deal restriction, blackout dates, and the like. An edit deal restrictions area may include binary selection controls for deal restriction selections such as treating a voucher the same as cash but without allowing a cash back redemption 1180, restricting the use of the associated voucher in combination with other offers or promotions 1182, or both. A blackout date section may include a calendar control for the selection of one or more deal blackout dates. Deal restriction and blackout date selections may be saved to the deal database 360 upon selection of a save restriction button control 1186.

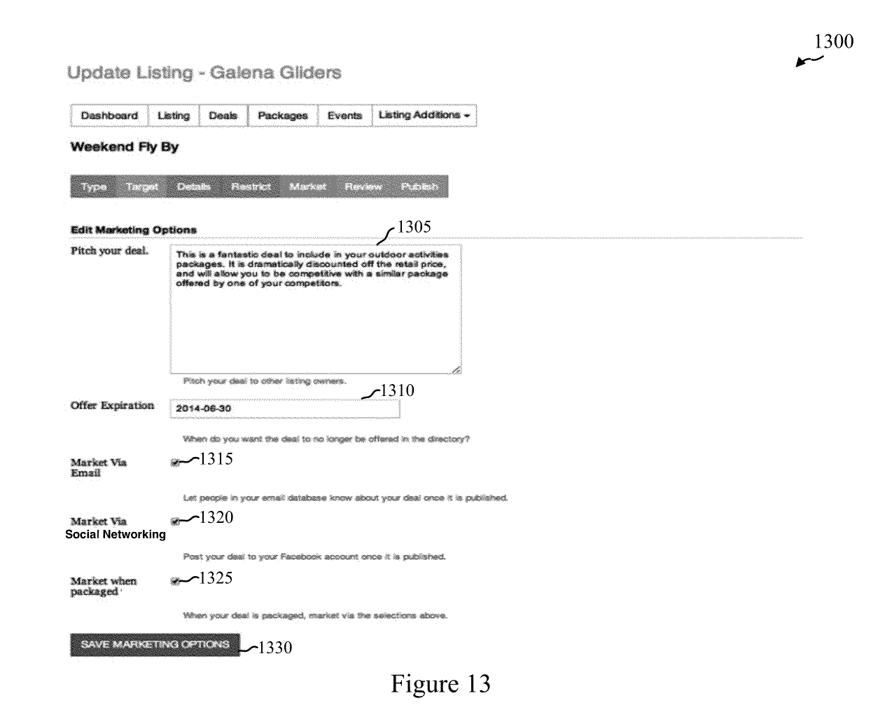

With reference to FIG. 13, the user may select the deal marketing option 925 described in reference to FIG. 9, whereupon screen 1300 may be displayed. Screen 1300 may present multiple options to enter details about the internal deal marketing, such as marketing to listing owners for the deal to be included in a deal package. Screen 1300 may display a pitch your deal text field 1305, an offer expiration field 1310, a market via email selection 1315, a marketing via social networking section 1320, and a market when packaged selection 1325. Once entered, these fields may populate the deal pitch 418, deal offer end 425, deal market email 426, deal market social networking 429, and deal market package 430 values in the respective deal record, as described above in reference to FIG. 4. At any point in entering the deal marketing information, a user may select the save marketing option 1330, whereby the information will be stored in the appropriate field of the deal record in deal database 360.

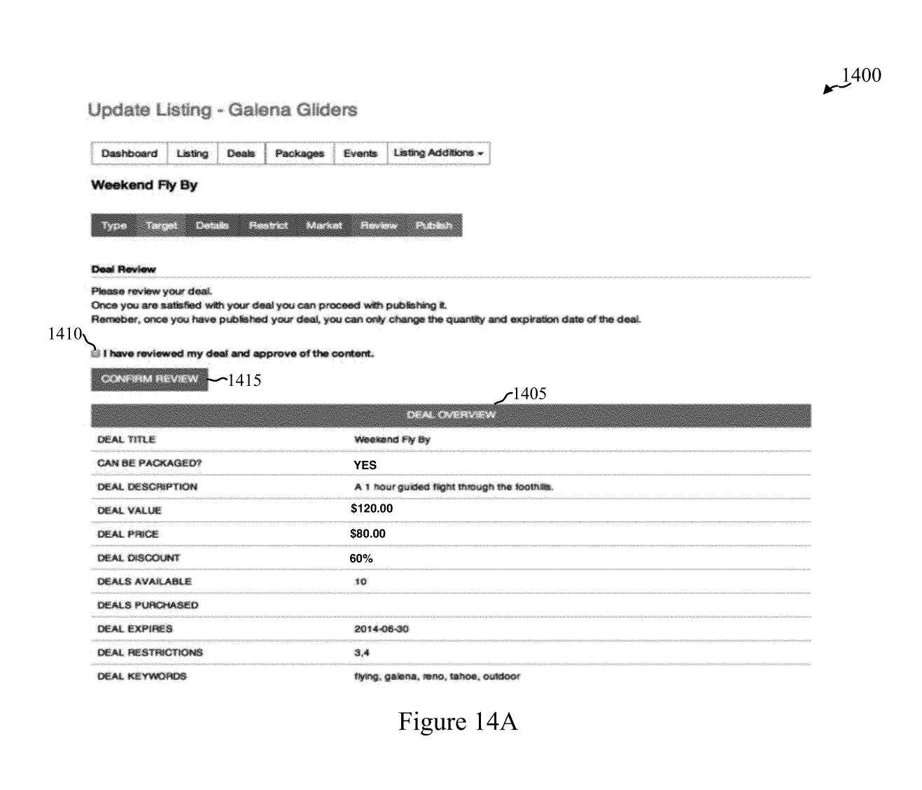

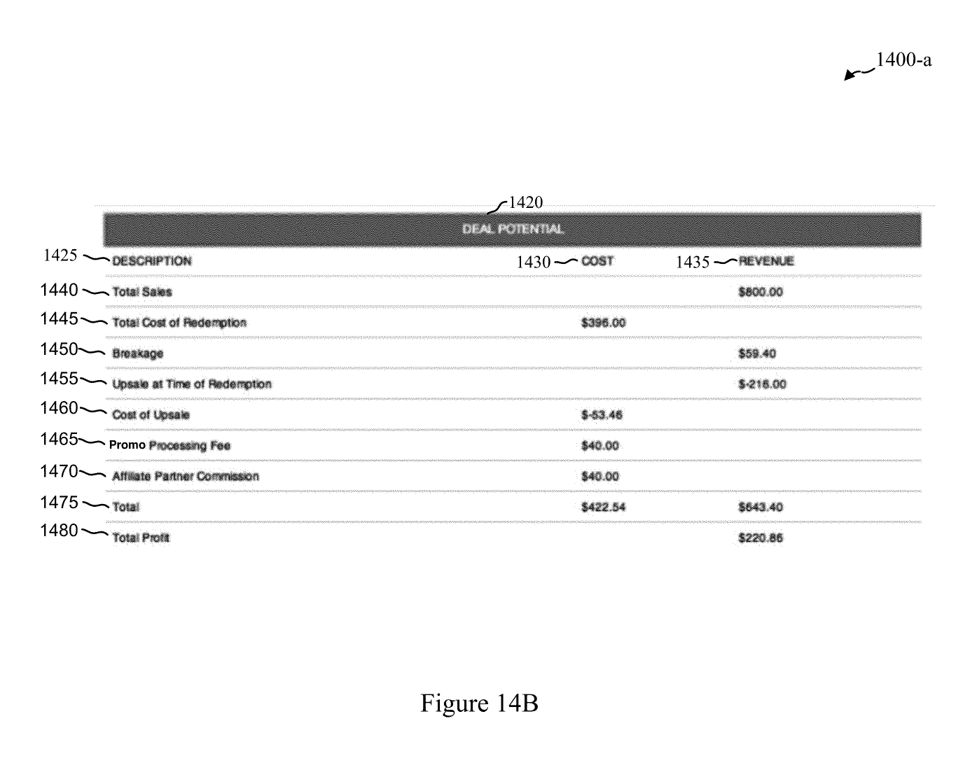

With reference to FIG. 14A-14B, the user may select the deal review option 926 described in reference to FIG. 9, whereupon screen 1400 may be displayed. Screen 1400 may display some or all of the entered deal information in a deal overview table 1405. Once the user has reviewed the information in the deal overview table 1405, and wishes to finalize the deal offering, the user may select a “I have reviewed the deal” option 1410 and then select a confirm review button 1415. Next, or in addition, screen 1400-a may display a deal potential table 1420. The deal potential table 1420 may list deal information organized by column, such as a description 1425, a cost 1430, and a revenue column 1435. The table 1420 may contain multiple rows, such as total sales 1440, total cost of redemption 1445, breakage 1450, upsale at time of redemption 1455, cost of upsale 1460, promo processing fee 1465, affiliate partner commission 1470, total 1475, and a total profit row 1480. The information in the deal potential table 1420 may be particularly useful to a deal vendor in assessing profitability of offering deals in the deal promotion platform.

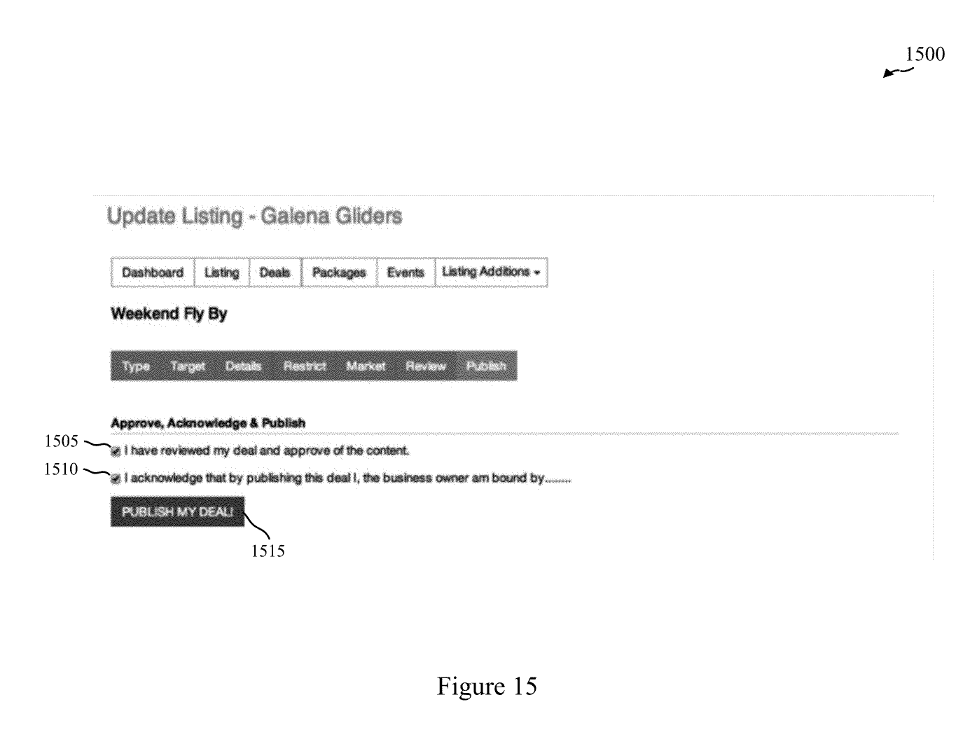

With reference to FIG. 15, the user may select the deal publish option 927 described in reference to FIG. 9, whereupon screen 1500 may be displayed. Screen 1500 may display options to further confirm review of the deal by the user. For example, screen 1500 may display a review and approve of content selection 1505 and an acknowledgement of the terms and conditions of publishing the deal selection 1510. Once those selections 1505, 1510 are selected, the user may then select the publish my deal button 1515, which may set the publish value 439 in the respect deal record to true.

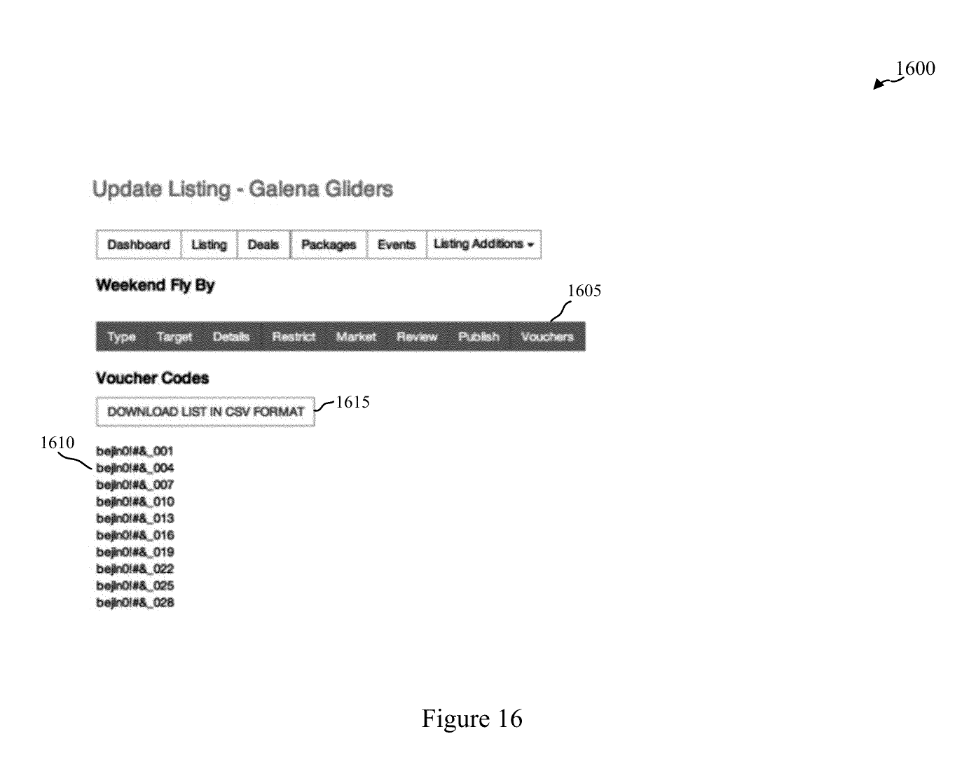

With reference to FIG. 16, a voucher codes screen 1600 is displayed. In some embodiments, a voucher code option 1605 may be included in the deal tool bar 920 described above in reference to FIG. 9. By selecting the voucher code option 1605, screen 1600 may be displayed. Screen 1600 may display a list of voucher codes 1610 that may include auto-generated voucher codes, or voucher codes manually entered by the user into the deal voucher codes field 1235 described above in reference to FIG. 12. Screen 1600 may also, present a download the voucher codes list selection 1615, that may enable external viewing, editing, etc., of the voucher code list.

With reference to FIG. 17A-17B, screens 1700 and 1700-a may be displayed by the deal promotion system after package creator authentication credentials have been received and verified. Screens 1700 and 1700-a may provide options and fields for a user to enter package configuration information. Screen 1700, for example, may display a package name text field 1705, a package title text field 1710 (title to be displayed), and a deal selection interface 1715. The deal selection interface 1715 may provide an option to limit deal results displayed to within a selectable distance via a distance selection option 1720. A first deal 1725 may be displayed for selection with relevant deal information such as price, a quantity still available, a deal expiration date, a deal offer end date, and the associated deal vendor/listing owner. In this example, the “Weekend Fly By” deal 1725, as described above in reference to FIGS. 8-16, is displayed as selected via a selection option 1730. Once a first deal is selected, a deal indicator 1735 may display the name of the selected deal for ease of reference. Other available deals 1726-1729 may further be displayed in the deal selection interface 1710. In this example, the “Lift Ticket for 2 to Galena Ski Resort” deal 1728 is selected via selection option 1733 and the name of the deal is displayed in a second deal indicator 1734.

Screen 1700-a may display further options and selections to configure a deal package, such as a package description text field 1740 and a tag key words text field 1745. Other package information fields may be auto-populated based on calculations performed on information retrieved from the deal records associated with the selected deals, such as via processes 600, 600-a, 600-b, and/or 700 as described above in reference to FIGS. 6A-7. The auto-populated fields may include package value 1750, package price 1755, quantity available 760, expiration date 1765, and package blackout dates 1770. The values entered and/or auto-populated in the package information fields may be stored or retrieved from the respective package record, such as values from the package name 444, package title 445, package description 446, package value 447, package price 448, package available 449, package offer end date 451, package keyword tags 452, and the package deals 455 fields. At any point in entering information, a user may select the save package and information option 1775 to store the entered information into the package database 361.

With reference to FIG. 18, a create deal package screen 1800, which may be displayed after all the package information is entered via screens 1700 and 1700-a, displays a create package option 1805. By selecting the create package option 1805, a user may indicate an intent to publish the package. In some embodiments, screen 1800 or another screen may display options for a user to first review and confirm the package information (not shown) and to accept terms of publishing (also not shown) before the create package option may be available for selection. Screen 1800, or another screen, may also display a package in-progress table 1810 that includes each package 1815 currently in-progress or offered by the user/listing owner and an indication 1820 of a percentage complete of the package 1825.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A automated deal creation method comprising:
providing an automated deal creation platform and through the automated deal creation platform:
limiting access to the automated deal creation platform to predetermined deal creators and predetermined deal package creators;
receiving from a first deal creator a first deal proposal including a first deal discount;
automatically providing the first deal creator with a package deal option to select inclusion of the first deal proposal in a deal package; and
if the first deal creator selects the package deal option, automatically generating a first deal package including the first deal proposal and a second deal proposal.

2. The automated deal creation method of claim 1, wherein the first deal package is associated with a deal package discount separate from the first deal discount of the first deal proposal and a second deal discount associated with the second deal proposal.

3. The automated deal creation method of claim 1, wherein the first deal proposal further comprises an available deal count, and wherein the deal promotion method further comprises automatically decrementing the available deal count each time the first deal proposal is included in the first deal package or another deal package.

4. The automated deal creation method of claim 1, further comprising receiving one or more package deal configuration parameters from a deal package creator; and wherein generating the first package deal is based on the one or more received package deal configuration parameters.

5. The automated deal creation method of claim 4, wherein the first deal creator is also the deal package creator.

6. The automated deal creation method of claim 1, wherein the second deal proposal is from a second deal creator.

7. The automated deal creation method of claim 1, wherein the first deal proposal further comprises one or more deal targets, and wherein the deal promotion method further comprises automatically publishing the first deal proposal to the one or more deal targets.

8. The automated deal creation method of claim 7, wherein the one or more deal targets comprises at least one or more of a business category, an activity category, a geographic location, or one or more individual businesses.

9. The automated deal creation method of claim 1, wherein the first deal proposal further comprises a first deal restriction and the second deal proposal comprises a second deal restriction, and wherein the automated deal creation method further comprises:
determining if the first deal restriction and second deal restriction conflict; and
adjusting generation of the deal package based on the determined conflict.

10. The method of claim 9, wherein the first deal restriction and the second deal restriction each further comprise a deal proposal expiration date and a deal proposal offer end date.

11. The method of claim 4, further comprising:
receiving a deal proposal request from the deal package creator; and
generating a request message based on the deal proposal request, wherein receiving the first deal proposal from the first deal creator is in response to the generated request message.

12. An automated promotion configuration method comprising:
receiving, at an automated deal promotion platform, deal configuration parameters for one or more deal proposals for a product or service;
automatically detecting, at the automated deal promotion platform, a package deal option selection event; and
automatically generating one or more deal redemption indicia based on the deal configuration parameters and the detected package deal option selection event.

13. The automated promotion configuration method of claim 1, further comprising:
receiving, at the automated deal promotion platform, one or more package configuration parameters from a deal package creator; and
automatically generating, at the automated deal promotion platform, one or more packages based on the deal redemption indicia and the one or more package configuration parameters.

14. The automated promotion configuration method of claim 13, wherein a deal package is automatically generated from a first deal redemption indicia associated with a first set of deal configuration parameters and a second deal redemption indicia associated with a second set of deal configuration parameters.

15. The automated promotion configuration method of claim 14, wherein the first set of deal configuration parameters comprises a first deal discount value and the second set of deal configuration parameters comprises a second deal discount value; and
wherein the deal package includes a package discount value separate from the first deal discount value and the second deal discount value.

16. The automated promotion configuration method of claim 14, wherein the first set of deal configuration parameters is associated with a first deal creator and the second set of deal configuration parameters is associated with a second deal creator.

17. The automated promotion configuration method of claim 13, further comprising receiving, at the deal promotion platform, one or more deal requests from a deal package creator.

18. The automated promotion configuration method of claim 13, wherein the package deal option selection parameter comprises at least one of a standalone deal selection or a deal package selection.

19. The automated promotion configuration method of claim 13, wherein the one or more deal redemption indicia are each associated with a remaining available deal count, and wherein the method further comprises automatically determining one or more remaining available deal counts.

20. A automated deal creation platform comprising:
means for limiting access to the automated deal creation platform to predetermined deal creators and predetermined deal package creators;
means for receiving from a first deal creator a first deal proposal including a first deal discount;
means for automatically providing the first deal creator with a package deal option to select inclusion of the first deal proposal in a deal package; and
means for automatically generating a first deal package including the first deal proposal and a second deal proposal, if the first deal creator selects the package deal option.
